(19) United States
(12) Patent Application Publication
(10) Pub. No.: US 2013/0063757 A1
(43) Pub. Date: Mar. 14, 2013

(54) INFORMATION PROCESSING APPARATUS, INFORMATION PROCESSING SYSTEM, AND NON-TRANSITORY COMPUTER READABLE MEDIUM FOR INFORMATION PROCESS

(71) Applicant: Yasuhiro Mori, Kanagawa (JP)

(72) Inventor: Yasuhiro Mori, Kanagawa (JP)

(73) Assignee: FUJI XEROX CO., LTD., Tokyo (JP)

(21) Appl. No.: 13/355,983

(22) Filed: Jan. 23, 2012

(30) Foreign Application Priority Data
Sep. 13, 2011 (JP) 2011-199534

(51) Int. Cl. G06F 3/12; G06K 15/00

(52) U.S. Cl. 358/1.14; 358/1.15

(57) ABSTRACT

An information processing apparatus includes a transmission component that transmits transmission target information to a transmission destination, a generation component that generates a transmission result screen based on a result of a transmission by the transmission component, a storage component that stores relation information between the transmission result screen and a transmission history performed by the transmission component, and a transmission result screen display component that specifies the transmission history corresponding to the transmission result screen based on the relation information, and displays the transmission result screen along with the specified transmission history.

### CROSS-REFERENCE TO RELATED APPLICATIONS

This application is based on and claims priority under 35 USC 119 from Japanese Patent Application No. 2011-199534 filed Sep. 13, 2011.

### BACKGROUND

### Technical Field

The present invention relates to an information processing apparatus, an information processing system, and a non-transitory computer readable medium for information process.

### SUMMARY

According to an aspect of the invention, there is provided an information processing apparatus including a transmission component that transmits transmission target information to a transmission destination; a generation component that generates a transmission result screen based on a result of a transmission by the transmission component; a storage component that stores relation information between the transmission result screen and a transmission history performed by the transmission component; and a transmission result screen display component that specifies the transmission history corresponding to the transmission result screen based on the relation information, and displays the transmission result screen along with the specified transmission history.

### BRIEF DESCRIPTION OF THE DRAWINGS

Exemplary embodiments of the present invention will be described in detail based on the following figures, wherein:

FIG. 1 is a diagram illustrating an information processing system according to a first exemplary embodiment;

FIG. 2 is a diagram illustrating a hardware configuration of the image processing apparatus shown in FIG. 1;

FIG. 3 is a diagram illustrating a hardware configuration of the information processing apparatus shown in FIG. 1;

FIG. 4 is a block diagram illustrating an information processing program which is operated in the information processing apparatus according to the first exemplary embodiment;

FIGS. 5A to 5C are diagrams exemplifying transmission result screens generated by the information processing apparatus;

FIG. 6 is a block diagram illustrating an image processing program which is operated in the image processing apparatus according to the first exemplary embodiment;

FIG. 7 is a diagram illustrating a configuration of the process transition unit shown in FIG. 6;

FIG. 8 is a diagram exemplifying a transmission processing screen from the information processing apparatus;

FIG. 9 is a diagram illustrating a configuration of the image reading processing portion shown in FIG. 6;

FIGS. 10A and 10B are diagrams exemplifying screens stored in the image reading screen DB;

FIG. 11 is a diagram exemplifying an updated transmission processing screen;

FIG. 12 is a diagram illustrating a configuration of the image data transmission processing portion shown in FIG. 6;

FIG. 13 is a diagram exemplifying a transmission execution screen;

FIGS. 14A and 14B are diagrams exemplifying transmission result screens generated by the image processing apparatus;

FIGS. 15A and 15B are diagrams illustrating a configuration of the transmission history display processing portion shown in FIG. 6;

FIG. 16 is a diagram exemplifying a transmission history screen displayed by the transmission history screen display unit;

FIG. 17 is a sequence diagram illustrating overall processes in the information processing system according to the first exemplary embodiment;

FIG. 18 is a flowchart illustrating processes after the image data transmission process in the image processing apparatus according to the first exemplary embodiment;

FIG. 19 is a block diagram illustrating an image processing program which is operated in an image processing apparatus according to a second exemplary embodiment;

FIG. 20 is a diagram illustrating a configuration of the image data transmission processing portion shown in FIG. 19;

FIGS. 21A and 21B are diagrams illustrating a configuration of the transmission history display processing portion shown in FIG. 19; and

FIG. 22 is a flowchart illustrating processes after the image data transmission process in the image processing apparatus according to the second exemplary embodiment.

### DETAILED DESCRIPTION

### First Exemplary Embodiment

First, a first exemplary embodiment will be described.

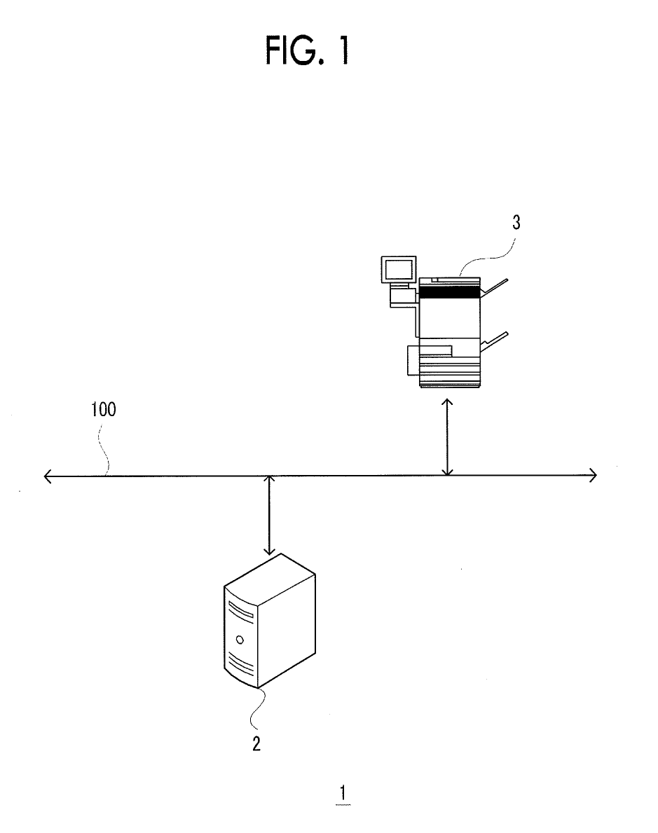

FIG. 1 is a diagram illustrating an information processing system 1 according to the first exemplary embodiment.

As shown in FIG. 1, the information processing system 1 includes an image processing apparatus 3 which is a first information processing apparatus and an information processing apparatus 2 which is a second information processing apparatus, connected to each other via a network 100 such as the Internet.

In addition, although the number of each of the information processing apparatus 2 and the image processing apparatus 3 is one in the exemplary embodiment, the number of each of them may be two or more.

The information processing apparatus 2 is, for example, a server or the like, and receives information and performs a process regarding the received information.

Specifically, the information processing apparatus 2 receives (uploads) information such as image data from the image processing apparatus 3, and stores the received image data.

In addition, when a terminal (not shown) connected to the network 100 requests the image data stored in the information processing apparatus 2, the information processing apparatus 2 transmits (downloads) the requested image data to the terminal.

The image processing apparatus 3 generates image data by reading an image from a recording medium (original document).

Further, the image processing apparatus 3 transmits (uploads) transmission target information such as image data to the information processing apparatus 2.

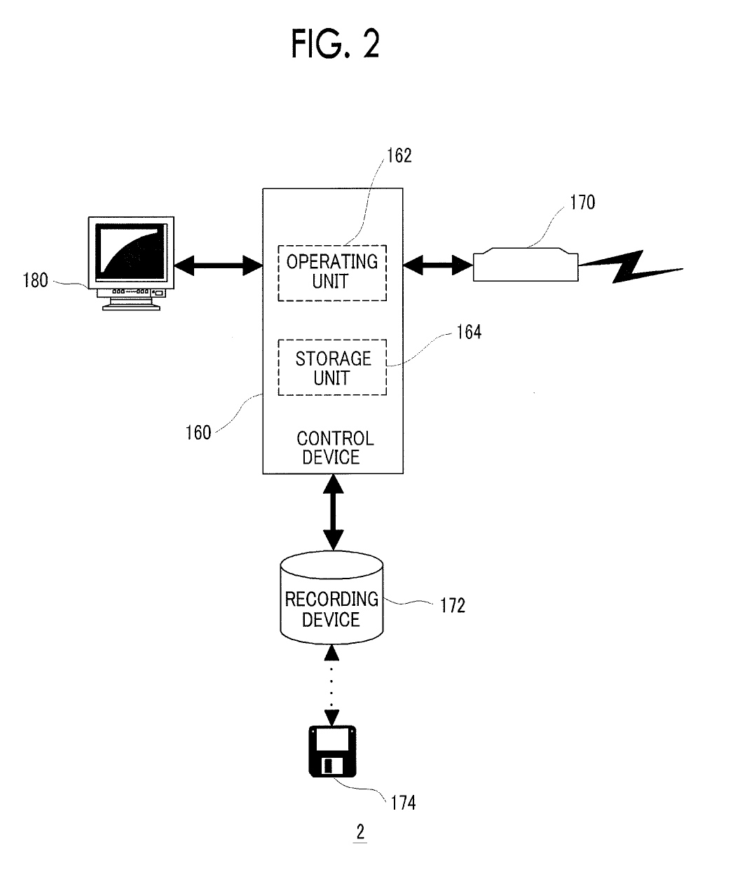

FIG. 2 is a diagram illustrating a hardware configuration of the information processing apparatus 2.

As shown in FIG. 2, the information processing apparatus 2 includes a control device 160 having an operating unit 162 such as a CPU, a storage unit 164 such as a memory, and the like, a communication device 170, a recording device 172, and a user interface device (UI device) 180.

That is to say, the information processing apparatus 2 has hardware constituent elements as a computer which can perform an information process and can communicate with other processing apparatuses or terminals.

In addition, in the following respective diagrams, the same reference numerals are given to substantially the same constituent elements and processes.

The UI device 180 includes a display device such as an LCD (Liquid Crystal Display) device or a CRT (Cathode Ray Tube) display device, a keyboard, a touch panel, and the like.

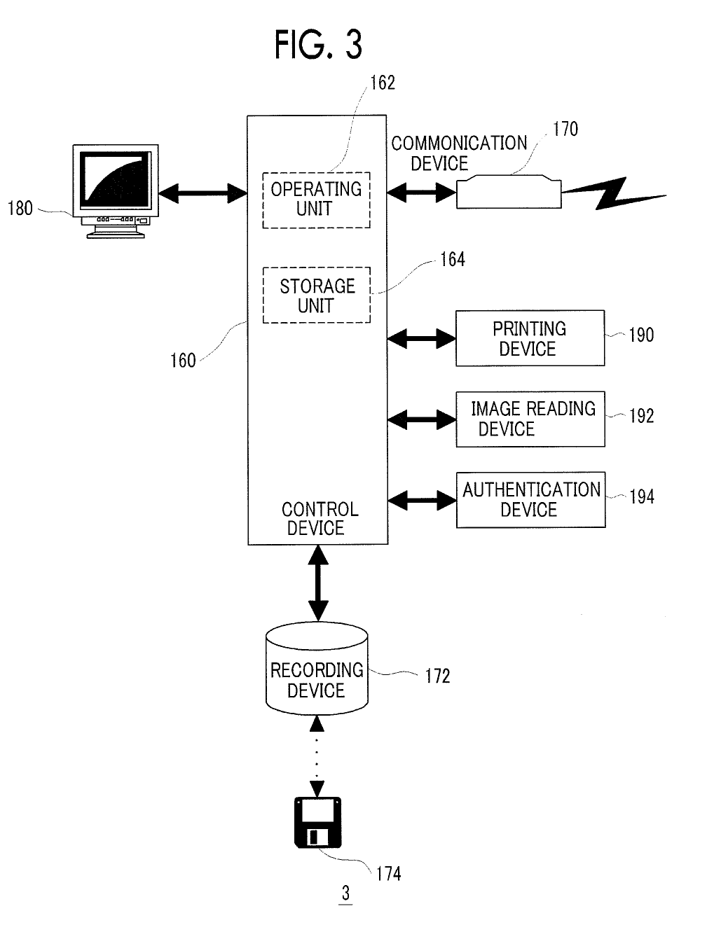

FIG. 3 is a diagram illustrating a hardware configuration of the information processing apparatus 2.

As shown in FIG. 3, the information processing apparatus 2 includes a control device 160 having an operating unit 162, a storage unit 164, and the like, a communication device 170, a recording device 172, a UI device 180, a printing device 190, an image reading device 192, and an authentication device 194.

The UI device 180 is, for example, a touch panel, and an operation screen is displayed on a display portion. When a user presses an operation button or the like shown in the operation screen, the image processing apparatus 3 performs a process corresponding to the operation button.

The printing device 190 is, for example, a printer or the like, and prints character data or image data on a recording medium such as paper.

The image reading device 192 is, for example, a scanner, and reads an image from a recording medium and converts the read image into image data.

The authentication device 194 performs an authentication process by receiving and combining, for example, a user identifier, a password, and the like such that the user of the image processing apparatus 3 may use the image processing apparatus 3 (available state), thereby performing a process (log-in or the like) for entering the available state.

In addition, the authentication device 194 cancels out the available state by receiving a user's operation, thereby performing a process (log-out or the like) where the user may not use the image processing apparatus 3 (unavailable state).

That is to say, the image processing apparatus 3 has hardware constituent elements as a computer which can perform an information process and can communicate with other processing apparatuses or terminals.

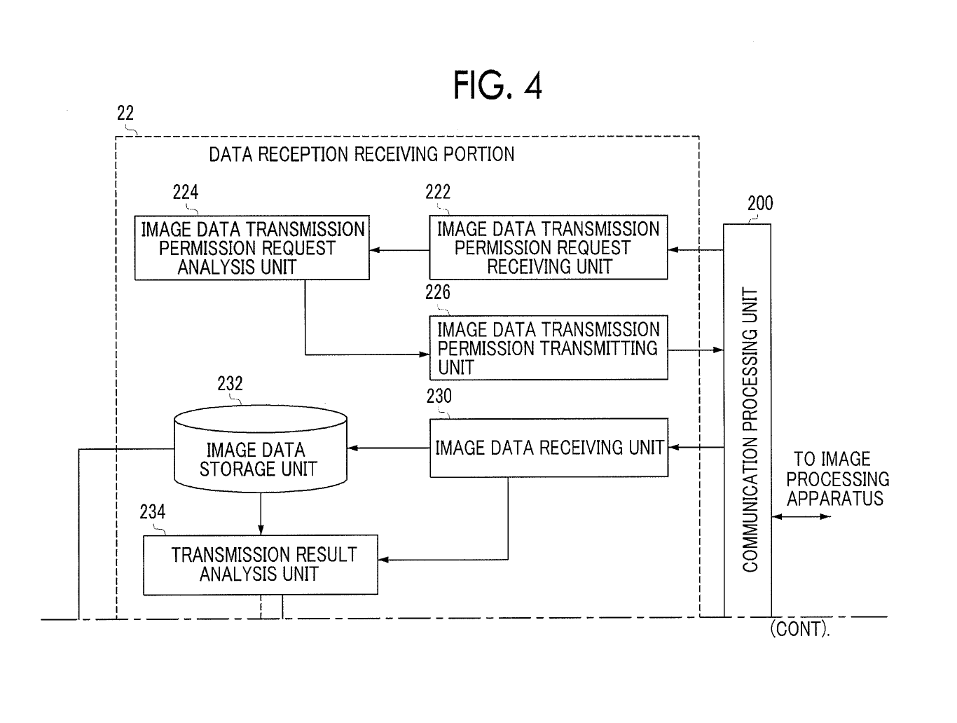

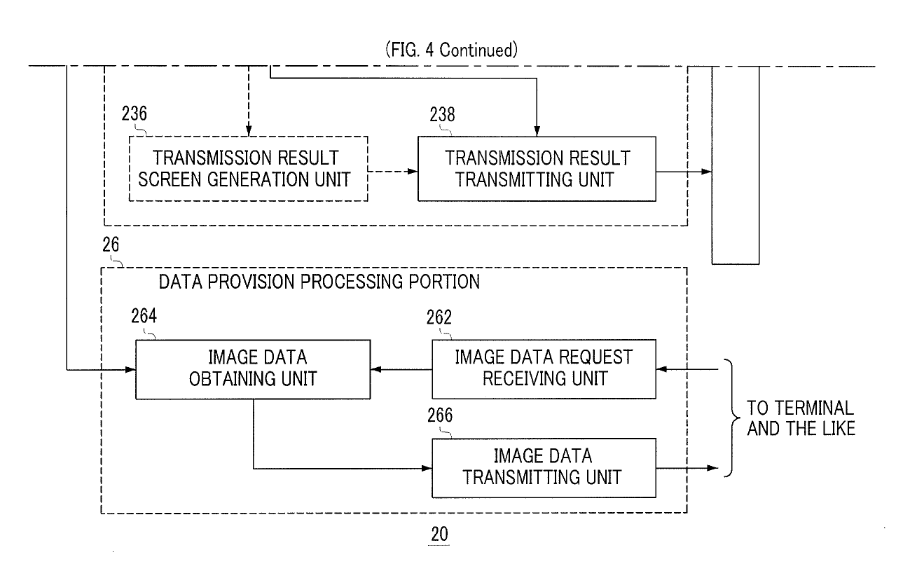

FIG. 4 is a block diagram illustrating an information processing program 20 which is operated in the information processing apparatus 2 according to the first exemplary embodiment.

As shown in FIG. 4, the information processing program 20 includes a communication processing unit 200, a data reception processing portion 22, and a data provision processing portion 26.

The information processing program 20 is executed by using hardware resources of the information processing apparatus 2 in detail, on an OS (not shown) which is supplied to the information processing apparatus 2 via, for example, the recording medium 174 (FIG. 2), stored in the storage unit 164, and installed in the information processing apparatus 2 (this is also true of each piece of software described below).

In the information processing program 20, the communication processing unit 200 performs processes necessary to communicate with the image processing apparatus 3 via the network 100.

The data reception processing portion 22 includes an image data transmission permission request receiving unit 222, an image data transmission permission request analysis unit 224, an image data transmission permission transmitting unit 226, an image data receiving unit 230, an image data storage unit 232, a transmission result analysis unit 234, a transmission result screen generation unit 236, and a transmission result transmitting unit 238.

The data reception processing portion 22 performs processes (upload) for receiving data (particularly, image data) from the image processing apparatus 3 for storage using the constituent elements.

The image data transmission permission request receiving unit 222 receives information (image data transmission permission request) indicating that the image processing apparatus 3 may transmit image data, from the image processing apparatus 3 via the network 100 and the communication processing unit 200.

In addition, the image data transmission permission request receiving unit 222 outputs the received image data transmission permission request to the image data transmission permission request analysis unit 224.

The image data transmission permission request analysis unit 224 extracts an identifier and an address of the image processing apparatus 3 which transmits the image data transmission permission request, from the image data transmission permission request, and determines whether or not to receive image data from the image processing apparatus 3.

If it is determined that image data may be received from the image processing apparatus 3, the image data transmission permission request analysis unit 224 outputs information (image data transmission permission information) indicating that the image data may be transmitted, to the image data transmission permission transmitting unit 226.

The image data transmission permission transmitting unit 226 transmits the image data transmission permission information to the image processing apparatus 3 which transmits the image data transmission permission request via the communication processing unit 200 and the network 100.

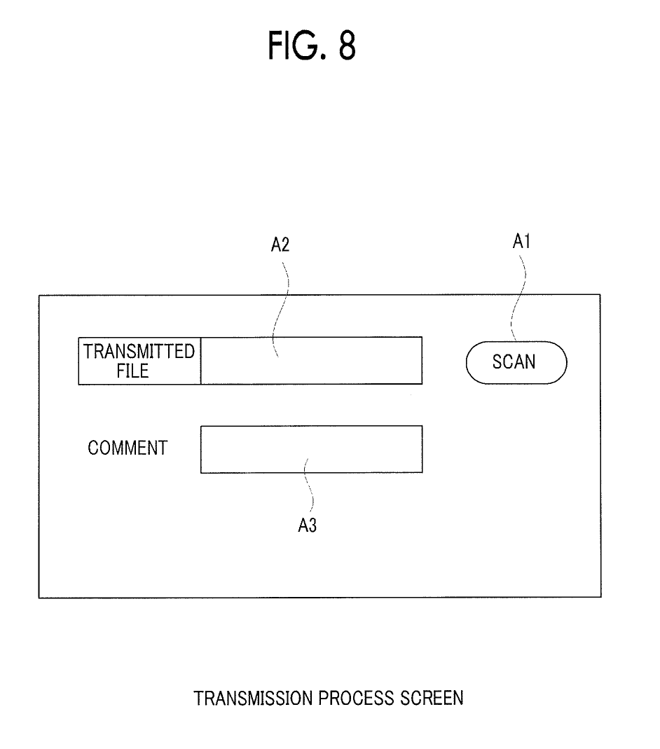

In this case, the image data transmission permission transmitting unit 226 may transmit information (transmission process screen information) indicating a transmission process screen (described later with reference to FIG. 8) used for an operation for transmitting image data in the image processing apparatus 3, to the image processing apparatus 3.

The image data receiving unit 230 receives the image data from the image processing apparatus 3 via the network 100 and the communication processing unit 200, and stores it in the image data storage unit 232.

The transmission result analysis unit 234 analyzes a transmission result of the image data from the image processing apparatus 3.

Specifically, the transmission result analysis unit 234 determines whether the image data is entirely received and is stored in the image data storage unit 232, the image data is entirely received but is not stored in the image data storage unit 232, only a part of the image data (or only header data) is received and the data may not be entirely received, or the like.

In addition, the transmission result analysis unit 234 outputs information indicating the transmission result (transmission result information) to the transmission result screen generation unit 236.

The transmission result screen generation unit 236 generates a screen corresponding to the transmission result (transmission result screen) indicated by the transmission result information, and outputs information indicating the transmission result screen (transmission result screen information) to the transmission result transmitting unit 238.

The transmission result screen generation unit 236, which stores, for example, a transmission result screen corresponding to transmission result information in advance, extracts corresponding transmission result screen information depending on received transmission result information, and outputs it to the transmission result transmitting unit 238.

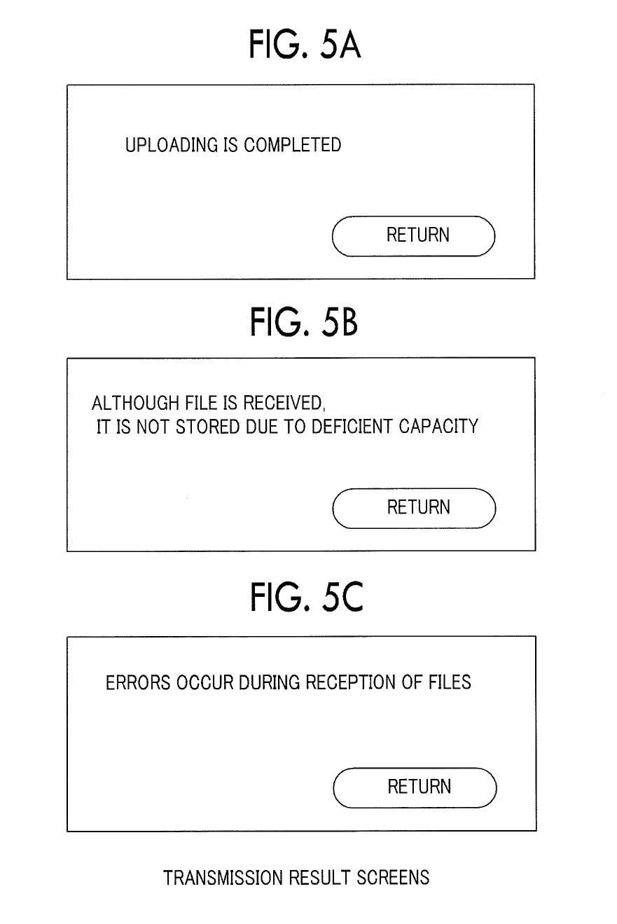

FIGS. 5A to 5C are diagrams exemplifying transmission result screens generated by the information processing apparatus 2.

FIG. 5A exemplifies a screen generated in a case where the transmission result analysis unit 234 determines that the image data is entirely received and stored in the image data storage unit 232.

FIG. 5B exemplifies a screen generated in a case where the transmission result analysis unit 234 determines that the image data is entirely received but is not stored in the image data storage unit 232.

FIG. 5C exemplifies a screen generated in a case where the transmission result analysis unit 234 determines that only a part of the image data is received and the data may not be entirely received.

The transmission result transmitting unit 238 (FIG. 4) transmits the transmission result screen and the transmission result information to the image processing apparatus 3 which transmits the image data, via the communication processing unit 200 and the network 100.

In addition, the transmission result screen generation unit 236 may be omitted. In this case, the transmission result analysis unit 234 outputs the transmission result information to the transmission result transmitting unit 238, and the transmission result transmitting unit 238 transmits only the transmission result information to the image processing apparatus 3 which transmits the image data, via the communication processing unit 200 and the network 100.

In this case, the transmission result information may not be related to whether or not the image data is stored in the image data storage unit 232 but may indicate whether or not transmission of the image data is successful.

Further, the data reception processing portion 22 may perform predetermined processes as well as storing image data.

For example, the data reception processing portion 22 may perform an OCR (Optical Character Recognition) process for the received image data so as to generate text data, and may store the text data along with the stored (uploaded) image data.

Further, for example, the data reception processing portion 22 may perform plural image processes for the received image data, and may store the processed image data so as to be correlated with the uploaded image data for each image process.

In addition to the screens shown in FIGS. 5A to 5C, the transmission result screen generation unit 236 may generate a screen including, for example, a notification, “the image process may not be completed because the size of the received file is large; and please upload again the file after reducing a resolution (changing the file size)” or a notification, “the format of the received file is not correct; and please upload again the file after changing to a version 3.0 format of XXX”.

The data provision processing portion 26 includes an image data request receiving unit 262, an image data obtaining unit 264, and an image data transmitting unit 266.

The data provision processing portion 26 provides (downloads) image data to the terminal (not shown) connected to the network 100 using the constituent elements.

The image data request receiving unit 262 receives information (image data request) for request for providing image data from the terminal via the network 100 and the communication processing unit 200.

In addition, the image data request receiving unit 262 outputs the image data request to the image data obtaining unit 264.

The image data obtaining unit 264 extracts an image data identifier from the image data request, and obtains image data corresponding to the identifier (file name or the like) from the image data storage unit 232.

In addition, the image data obtaining unit 264 outputs the obtained image data to the image data transmitting unit 266.

The image data transmitting unit 266 transmits the obtained image data to the terminal which requests the image data via the communication processing unit 200 and the network 100.

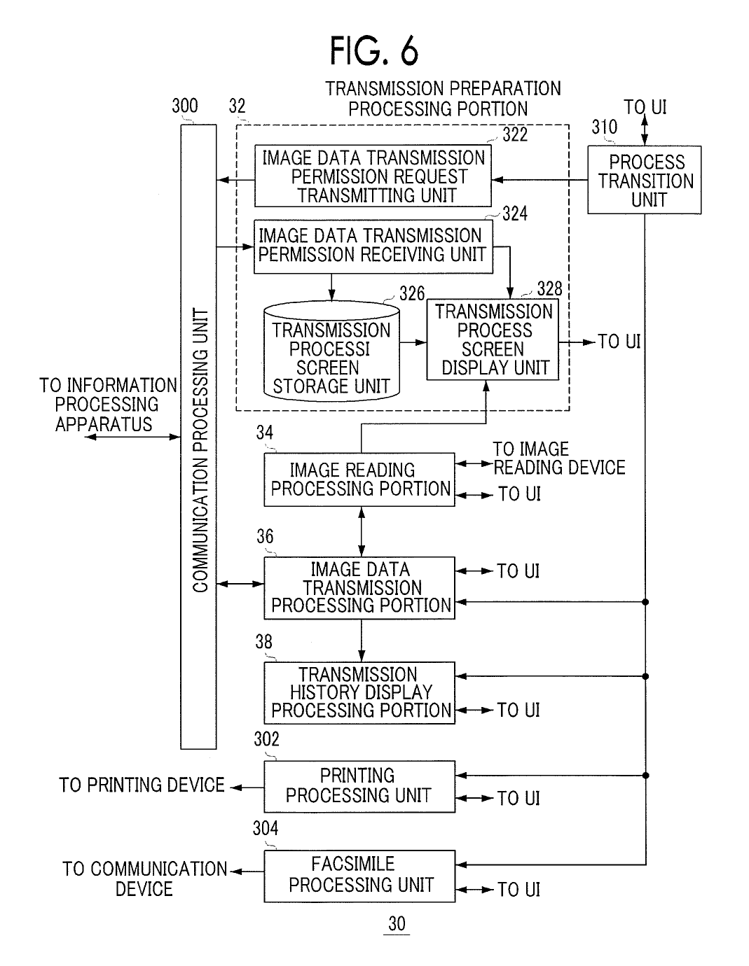

FIG. 6 is a block diagram illustrating an image processing program 30 operated in the image processing apparatus 3 according to the first exemplary embodiment.

As shown in FIG. 6, the image processing program 30 includes a communication processing unit 300, a printing processing unit 302, a facsimile processing unit 304, a process transition unit 310, a transmission preparation processing portion 32, an image reading processing portion 34, an image data transmission processing portion 36, and a transmission history display processing portion 38.

In addition, the communication processing unit 300, the printing processing unit 302, the facsimile processing unit 304, the process transition unit 310, the transmission preparation processing portion 32, the image reading processing portion 34, the image data transmission processing portion 36, and the transmission history display processing portion 38 may be realized by, for example, application software such as a web browser.

In the image processing program 30, the communication processing unit 300 performs processes necessary to communicate with the information processing apparatus 2 via the network 100.

The process transition unit 310 transitions plural function processes which the image processing apparatus 3 has.

The printing processing unit 302 controls the printing device 190 (FIG. 3) so as to perform a process (printing process) for printing an image on a recording medium such as paper.

Further, the printing processing unit 302 displays a screen (operation screen or the like) for the printing process on the UI device 180.

The facsimile processing unit 304 controls the communication device 170 so as to perform a process (facsimile process) for transmitting image information to devices (not shown) connected to the network 100.

In addition, the facsimile processing unit 304 displays a screen (operation screen or the like) for the facsimile process on the UI device 180.

The transmission preparation processing portion 32 performs a preprocess for transmitting information (image data) indicating an image formed on the recording medium for storage (upload), to the information processing apparatus 2.

The image reading processing portion 34 controls the image reading device 192 so as to perform a process (image reading process) for reading an image formed on the recording medium (original document) and generating image data.

The image data transmission processing portion 36 performs a process (image data transmission process) for transmitting the image data to the information processing apparatus 2.

The transmission history display processing portion 38 performs a process (transmission history display process) for displaying a screen indicating a data transmission result (whether the data is normally transmitted or errors occur during transmission).

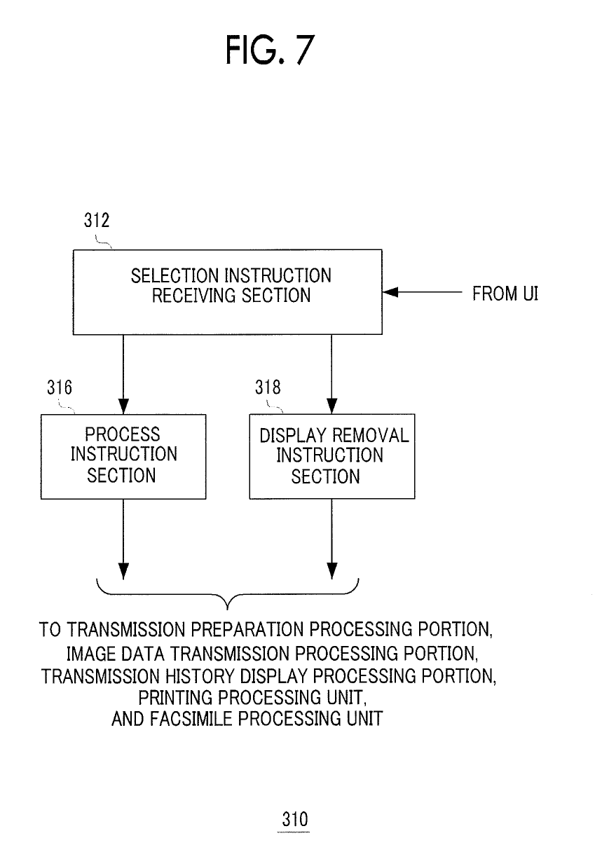

FIG. 7 is a diagram illustrating a configuration of the process transition unit 310 shown in FIG. 6.

As shown in FIG. 7, the process transition unit 310 includes a selection instruction receiving section 312, a process instruction section 316, and a display removal instruction section 318.

In the process transition unit 310, the selection instruction receiving section 312 receives information (process selection information) indicating an instruction for a selected process from the UI device 180.

The process selection information may be obtained by a user operating the UI device 180.

In addition, the selection instruction receiving section 312 outputs the process selection information to the process instruction section 316 and the display removal instruction section 318.

The process instruction section 316 outputs information (process execution instruction) for instructing constituent elements which perform processes indicated by the process selection information to perform corresponding processes, to the respective constituent elements.

The display removal instruction section 318 outputs information (display removal instruction) for instructing constituent elements other than the constituent elements which perform processes indicated by the process selection information to remove display for the processes from the UI device 180, to the respective constituent elements.

For example, it is assumed that when the image processing apparatus 3 executes a “printing process”, the process selection information indicating that a “transmission history display process” is selected is received from the UI device 180.

In this case, the process instruction section 316 outputs a process execution instruction for instructing the transmission history display process to be executed, to the transmission history display processing portion 38.

In addition, the display removal instruction section 318 outputs a display removal instruction for instructing a screen for the printing process to be removed from the display device of the UI device 180, to the printing processing unit 302.

Further, a process which does not use the UI device 180 among processes during the execution may be continued without interruption even if a transitioned process is started after a screen for the processes during the execution is removed from the display device of the UI device 180.

For example, in the above example, a process (for example, a process after a user presses the printing start button) which does not use the UI device 180 among the “printing processes” during execution may be continued without interruption even if a process performed by the transmission history display processing portion 38 is started after the screen for the printing processes is removed from the display device of the UI device 180.

The transmission preparation processing portion 32 (FIG. 6) includes an image data transmission permission request transmitting unit 322, an image data transmission permission receiving unit 324, a transmission process screen storage unit 326, and a transmission process screen display unit 328.

In the transmission preparation processing portion 32, the image data transmission permission request transmitting unit 322 transmits an image data transmission permission request to the information processing apparatus 2 via the communication processing unit 300 and the network 100.

The image data transmission permission receiving unit 324 receives the image data transmission permission information from the information processing apparatus 2 via the network 100 and the communication processing unit 300.

Here, when the information processing apparatus 2 transmits transmission process screen information, the image data transmission permission receiving unit 324 receives the transmission process screen information along with the image data transmission permission information and stores the transmission process screen information in the transmission process screen storage unit 326.

The transmission process screen display unit 328 obtains the transmission process screen information received from the information processing apparatus 2, from the transmission process screen storage unit 326, and displays a corresponding transmission process screen on the UI device 180.

In addition, if the transmission process screen information is not received from the information processing apparatus 2, the transmission process screen display unit 328 displays a screen for the image reading process which is stored in advance in the image processing apparatus 3, on the UI device 180.

FIG. 8 is a diagram exemplifying a transmission process screen from the information processing apparatus 2.

As shown in FIG. 8, the transmission process screen includes an operation button A1 for reading an image from a recording medium, a file name display part A2 for displaying a transmitted file name which is an identifier of image data to be transmitted, and a comment field A3 for displaying comments which are arbitrarily input by a user with regard to image data.

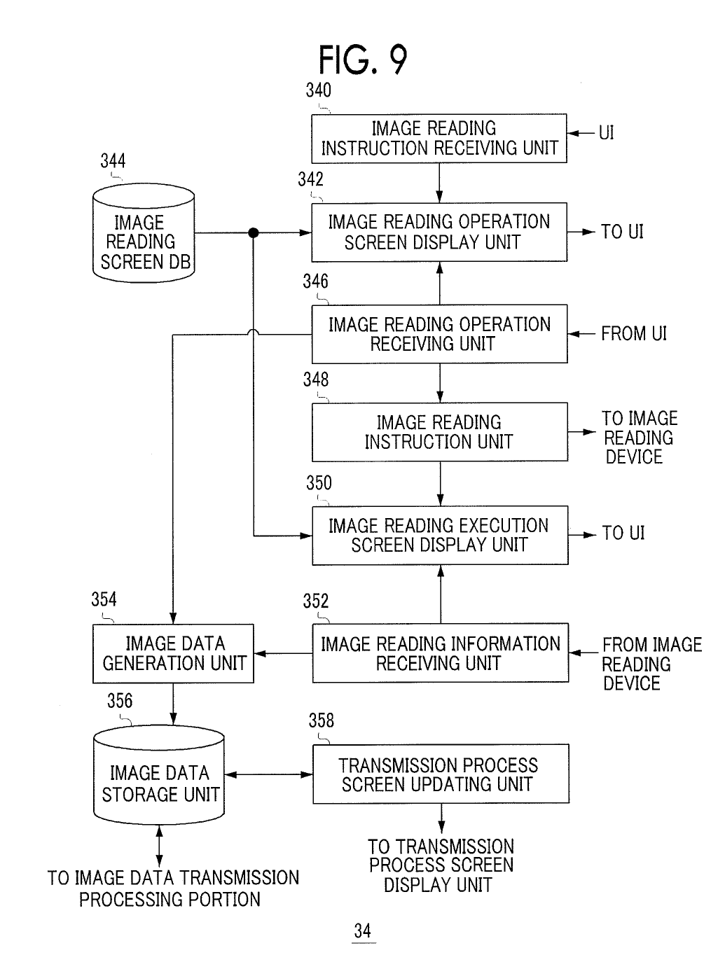

FIG. 9 is a diagram illustrating a configuration of the image reading processing portion 34 shown in FIG. 6.

As shown in FIG. 9, the image reading processing portion 34 includes an image reading instruction receiving unit 340, an image reading operation screen display unit 342, an image reading screen database (DB) 344, an image reading operation receiving unit 346, an image reading instruction unit 348, an image reading execution screen display unit 350, an image reading information receiving unit 352, an image data generation unit 354, an image data storage unit 356, and a transmission process screen updating unit 358.

In the image reading processing portion 34, the image reading instruction receiving unit 340 receives information (image reading instruction information) indicating an instruction for executing a process for reading image from a recording medium, from the UI device 180, and outputs the information to the image reading operation screen display unit 342.

The image reading instruction information may be obtained, for example, by a user pressing the operation button A1 of the transmission process screen (FIG. 8) displayed on the UI device 180.

When receiving the image reading instruction information, the image reading operation screen display unit 342 obtains information corresponding to an operation screen (image reading operation screen) for reading an image from the recording medium, from the image reading screen DB 344, and displays the image reading operation screen on the UI device 180.

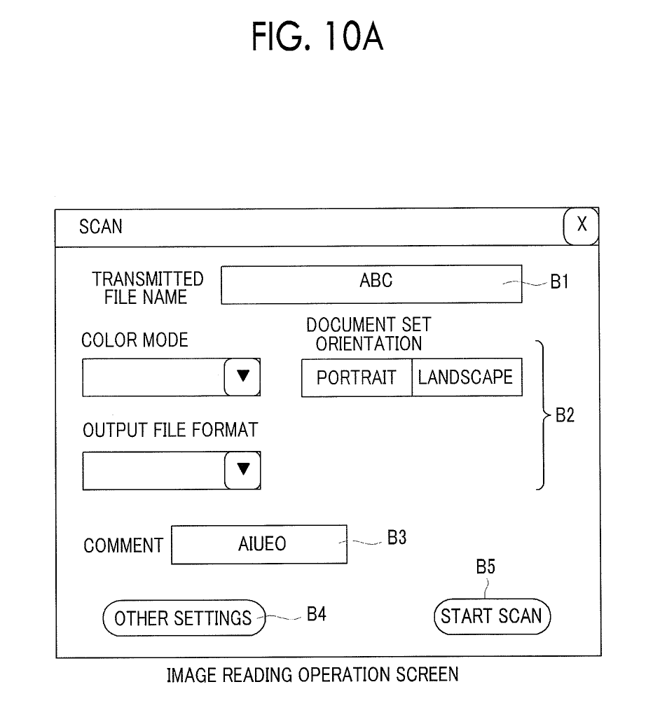

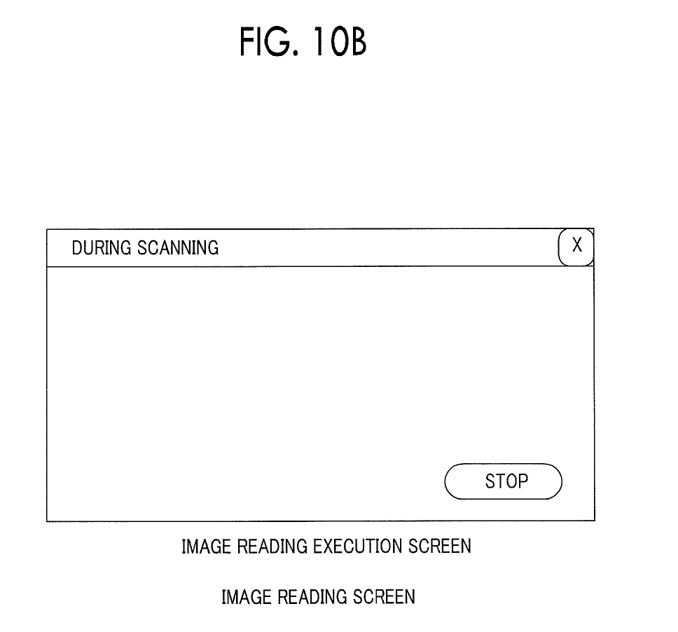

FIGS. 10A and 10B are diagrams exemplifying screens stored in the image reading screen DB 344, where FIG. 10A shows an image reading operation screen, and FIG. 10B shows an image reading execution screen described later.

As shown in FIG. 10A, the image reading operation screen includes a file name input part B1 for inputting a file name which is an identifier of image data to be read, an operation button B2 for changing basic settings, a comment input part B3 for inputting comments, a transition button B4 for transition to a screen (not shown) for performing other settings than B2, and a start button B5 for starting image reading.

The image reading operation receiving unit 346 (FIG. 9) receives information (image reading operation information) indicating an operation regarding the image reading operation screen shown in FIG. 10A, from the UI device 180.

Specifically, for example, if a user inputs a file name, the user operates the keyboard and the like of the UI device 180 by pressing the file name input part B1, and thus image reading operation information indicating the file name is generated.

In addition, if color modes are changed, the user selects a desired color mode by pressing the operation button B2, and thus image reading operation information indicating a desired color mode is generated.

When receiving the image reading operation information generated by the user operating, for example, the file name input part B1 or the comment input part B3, the image reading operation receiving unit 346 outputs information indicating the file name or the comment included in the image reading operation information to the image data generation unit 354.

Further, when receiving the image reading operation information generated by the user operating, for example, the operation button B2, the image reading operation receiving unit 346 instructs the image reading operation screen display unit 342 to display an image reading operation screen which reflects the changed setting.

In addition, when receiving the image reading operation information generated by the user operating, for example, the transition button B4, the image reading operation receiving unit 346 instructs the image reading operation screen display unit 342 to display another setting screen.

Further, when receiving the image reading operation information generated by the user operating the start button B5, the image reading operation receiving unit 346 outputs a signal indicating the reception of the image reading operation information to the image reading instruction unit 348.

When receiving the signal from the image reading operation receiving unit 346, the image reading instruction unit 348 controls the image reading device 192 so as to read an image from the recording medium.

In addition, when image reading is started, the image reading instruction unit 348 outputs a signal indicating the progress of the image reading to the image reading execution screen display unit 350.

The image reading execution screen display unit 350 obtains information corresponding to the screen (image reading execution screen) indicating the progress of the image reading from the image reading screen DB 344, as shown in FIG. 10B, and displays the image reading execution screen on the UI device 180.

At this time, when the stop button displayed in the image reading execution screen is pressed by the user, the image reading instruction unit 348 performs a control so as to stop the image reading, and the image reading execution screen display unit 350 removes the display of the image reading execution screen.

The image reading information receiving unit 352 receives image reading information obtained by reading an image from the recording medium from the image reading device 192, and outputs the image reading information to the image data generation unit 354.

In addition, when receiving the image reading information, the image reading information receiving unit 352 instructs the image reading execution screen display unit 350 to remove the display of the image reading execution screen.

The image data generation unit 354 generates image data by performing a predetermined process for the image reading information, and correlates the file name or the like from the image reading operation receiving unit 346 with the image data for storage in the image data storage unit 356.

In addition, the image data generation unit 354 generates a thumbnail image (reduced image) of the image data, and stores the thumbnail image in the image data storage unit 356.

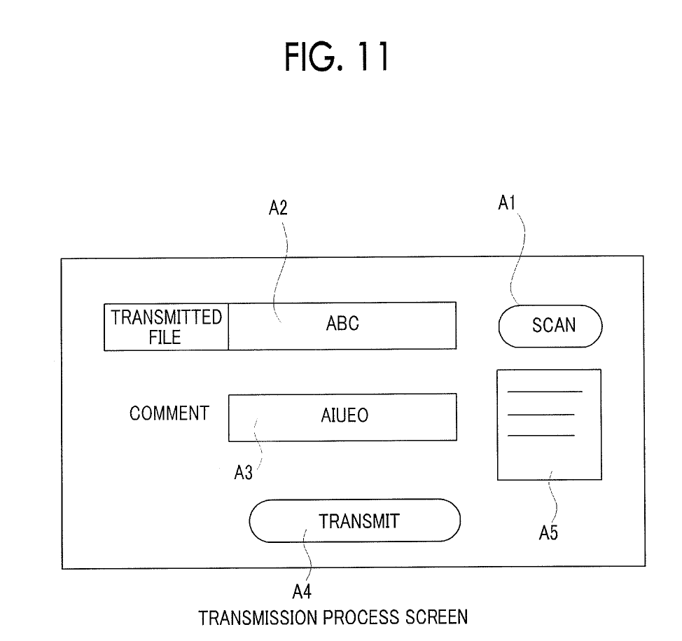

The transmission process screen updating unit 358 instructs the transmission process screen display unit 328 to update the display of the transmission process screen as exemplified in FIG. 11.

FIG. 11 is a diagram exemplifying an updated transmission process screen.

As shown in FIG. 11, the transmission process screen updating unit 358 adds a file name to the file name display part A2 of the transmission process screen and adds a comment to the comment field A3 for display.

In addition, the transmission process screen updating unit 358 adds the reduced image of the image data to the transmission process screen for display.

Further, the transmission process screen updating unit 358 adds a transmission button A4 for transmitting the image data to the information processing apparatus 2 to the transmission process screen for display.

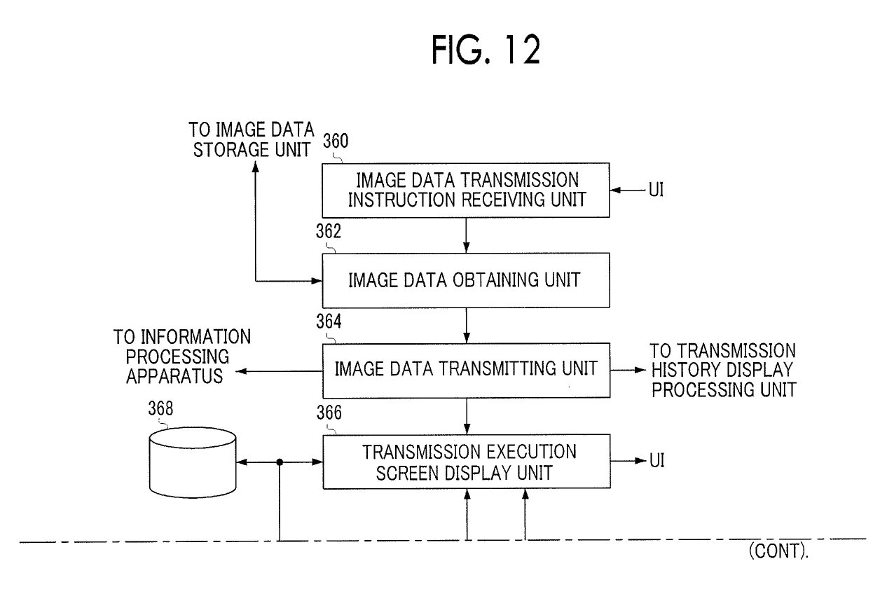

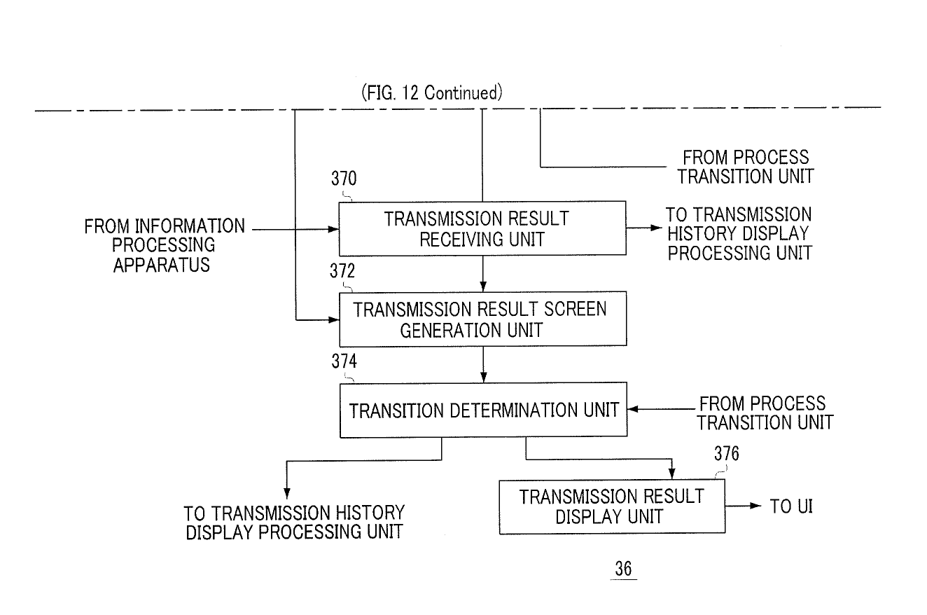

FIG. 12 is a diagram illustrating a configuration of the image data transmission processing portion 36 shown in FIG. 6.

As shown in FIG. 12, the image data transmission processing portion 36 includes an image data transmission instruction receiving unit 360, an image data obtaining unit 362, an image data transmitting unit 364, a transmission execution screen display unit 366, a transmission screen DB 368, a transmission result receiving unit 370, a transmission result screen generation unit 372, a transition determination unit 374, and a transmission result display unit 376.

In the image data transmission processing portion 36, the image data transmission instruction receiving unit 360 receives information (image data transmission instruction information) indicating an instruction for transmitting image data to the information processing apparatus 2, from the UI device 180, and outputs the information to the image data obtaining unit 362.

The image data transmission instruction information may be obtained, for example, by the user pressing the transmission button A4 of the transmission process screen (FIG. 11) displayed on the UI device 180.

When receiving the image data transmission instruction information, the image data obtaining unit 362 obtains the image data from the image data storage unit 356 of the image reading processing portion 34, and outputs the obtained image data to the image data transmitting unit 364.

In addition, the image data obtaining unit 362 may obtain image data which is stored in the image processing apparatus 3 in advance instead of the image read from the recording medium, or may obtain image data from other apparatuses.

The image data transmitting unit 364 transmits the image data to the information processing apparatus 2 via the communication processing unit 300 and the network 100.

In addition, when the transmission of the image data is started, the image data transmitting unit 364 outputs a signal (image data transmission signal) indicating the progress of the image data transmission to the transmission execution screen display unit 366.

Further, when the transmission of the image data is started, the image data transmitting unit 364 outputs the image data transmission signal to the transmission history display processing portion 38.

The transmission execution screen display unit 366 obtains information corresponding to a screen (transmission execution screen) indicating that the image data is being transmitted, from the transmission screen DB 368, and displays the transmission execution screen on the UI device 180.

If a process in the image processing apparatus 3 is transitioned from the transmission process to other processes by the process transition unit 310, the transmission execution screen display unit 366 removes the display of the transmission execution screen by receiving a display removal instruction from the process transition unit 310.

In addition, even in a case of being transitioned to other processes, a series of transmission processes performed by the image data transmitting unit 364, the transmission result receiving unit 370, the transmission result screen generation unit 372, and the transition determination unit 374 is not stopped, but these processes are continuously performed.

That is to say, in a case of being transitioned to other processes during the image data transmission, although the screen displayed on the UI device 180 is changed to a screen regarding a process after the transition, a series of transmission processes performed by the image data transmitting unit 364, the transmission result receiving unit 370, the transmission result screen generation unit 372, and the transition determination unit 374 is continuously performed.

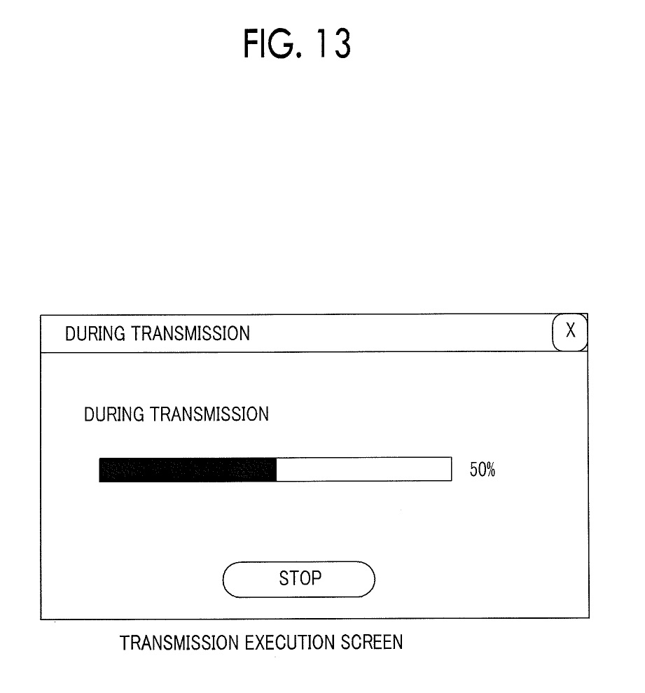

FIG. 13 is a diagram exemplifying a transmission execution screen.

As shown in FIG. 13, the transmission execution screen may show a transmission rate of image data.

In addition, a stop button is displayed in the transmission execution screen, and if the user presses the stop button, the image data transmitting unit 364 stops the image data transmission, and the transmission execution screen display unit 366 removes the display of the image reading execution screen.

The transmission result receiving unit 370 (FIG. 12) receives the transmission result information and the transmission result screen information from the transmission result transmitting unit 238 of the information processing apparatus 2 via the network 100 and the communication processing unit 300.

However, in a case where the transmission result transmitting unit 238 transmits only the transmission result information, the transmission result receiving unit 370 does not receive the transmission result screen information but receives only the transmission result information.

In addition, in a case where the transmission result information is not received from the information processing apparatus 2 even after a predetermined time has elapsed since the image data transmitting unit 364 starts transmitting the image data, the transmission result receiving unit 370 generates the transmission result information indicating that the transmission fails.

If the transmission result information is received (or if the transmission result information is generated), the transmission result receiving unit 370 outputs the transmission result information to the transmission result screen generation unit 372 and the transmission history display processing portion 38.

In addition, if the transmission result information is received (or if the transmission result information is generated), the transmission result receiving unit 370 instructs the transmission execution screen display unit 366 to remove the display of the transmission execution screen.

The transmission result screen generation unit 372 generates a transmission result screen corresponding to a transmission result indicated by the transmission result information, and outputs transmission result screen information indicating the transmission result screen to the transition determination unit 374.

The transmission result screen generation unit 372 extracts, for example, transmission result screen information corresponding to the transmission result information from the transmission screen DB 368 for output to the transition determination unit 374.

In addition, if the transmission result screen information is received from the information processing apparatus 2, the transmission result screen generation unit 372 does not generate transmission result screen information, and outputs the transmission result screen information from the information processing apparatus 2 to the transition determination unit 374.

The transition determination unit 374 receives a process execution instruction or a display removal instruction from the process transition unit 310, and determines whether the process in the image processing apparatus 3 is an image data transmission process or is transitioned to another process (a printing process or the like).

Specifically, when the transmission result receiving unit 370 receives the transmission result information, the transition determination unit 374 determines whether the process is the image data transmission process or is transitioned to another process (a printing process or the like).

If it is determined that the process in the image processing apparatus 3 is the image data transmission process and is not transitioned to another process, the transition determination unit 374 outputs transmission result screen information to the transmission result display unit 376.

On the other hand, if it is determined that the process in the image processing apparatus 3 is transitioned to another process, the transition determination unit 374 outputs the transmission result screen information to the transmission history display processing portion 38 so as to display a subsequent transmission result screen.

In addition, if a transition to another process is performed but a transition to the image data transmission process is performed again at the time of the determination, the transition determination unit 374 may output the transmission result screen information to the transmission result display unit 376.

The transmission result display unit 376 displays a transmission result screen corresponding to the transmission result screen information on the UI device 180.

Further, the transmission result display unit 376 may delete the corresponding transmission result screen information when the transmission result screen is displayed.

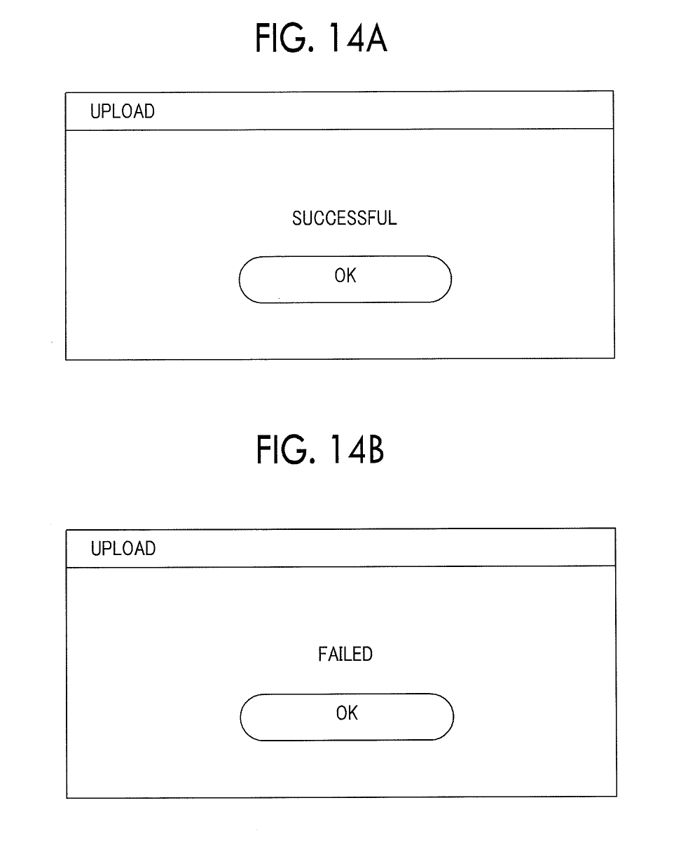

FIGS. 14A and 14B are diagrams exemplifying transmission result screens generated by the image processing apparatus 3.

FIG. 14A exemplifies a screen generated when the transmission result information received from the information processing apparatus 2 indicates that the image data transmission is successful.

FIG. 14B exemplifies a screen generated when the transmission result information received from the information processing apparatus 2 indicates that the image data transmission fails.

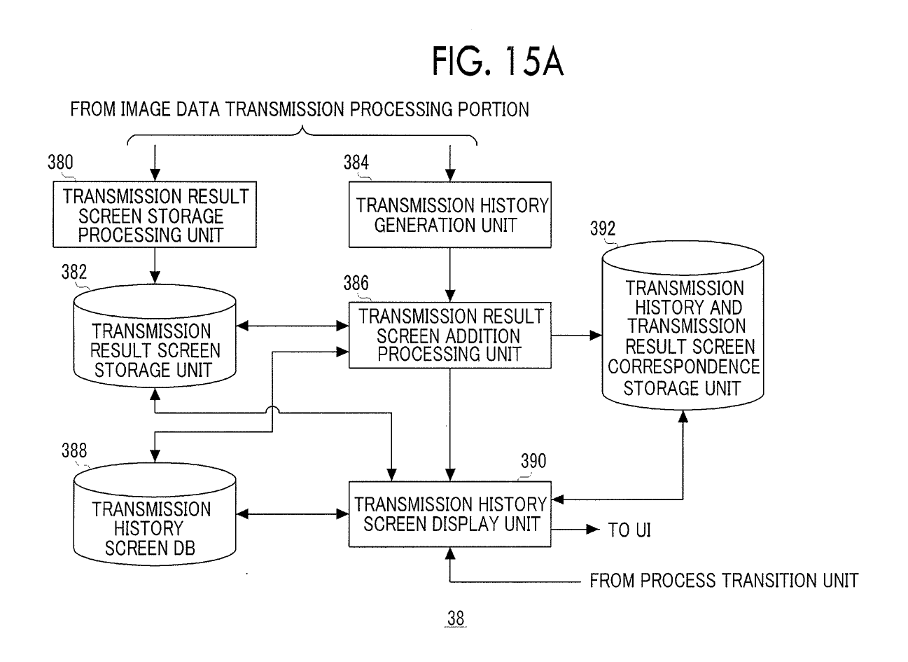

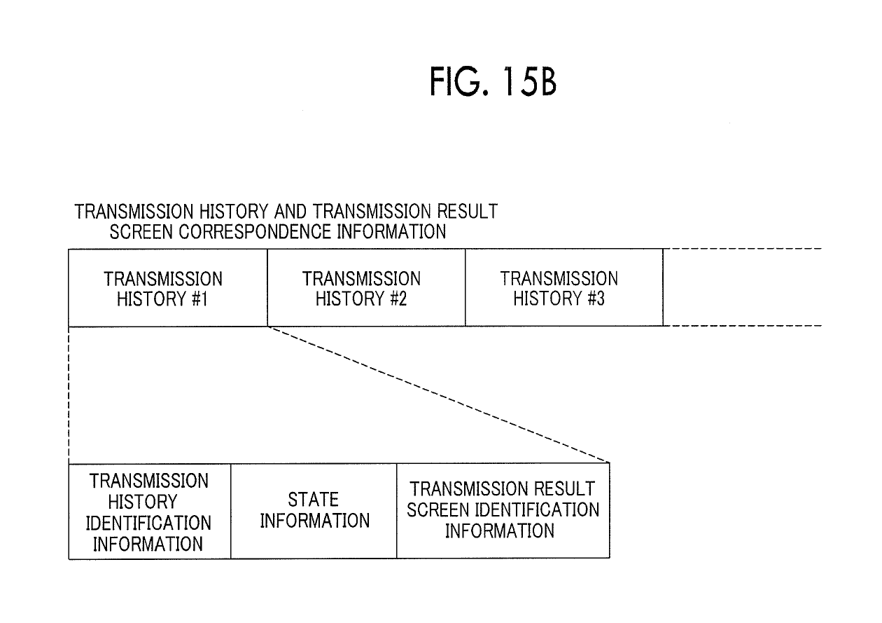

FIGS. 15A and 15B are diagrams illustrating a configuration of the transmission history display processing portion 38 shown in FIG. 6, where FIG. 14A shows a configuration of the transmission history display processing portion 38, and FIG. 14B exemplifies information stored in a transmission history and transmission result screen correspondence storage unit 392 described later.

As shown in FIG. 15A, the transmission history display processing portion 38 includes a transmission result screen storage processing unit 380, a transmission result screen storage unit 382, a transmission history generation unit 384, a transmission result screen addition processing unit 386, a transmission history screen DB 388, a transmission history screen display unit 390, and the transmission history and transmission result screen correspondence storage unit 392.

In the transmission history display processing portion 38, the transmission result screen storage processing unit 380 receives the transmission result screen information from the transition determination unit 374 of the image data transmission processing portion 36 for storage in the transmission result screen storage unit 382.

The transmission history generation unit 384 receives the image data transmission signal from the image data transmitting unit 364 of the image data transmission processing portion 36 and receives the transmission result information from the transmission result receiving unit 370.

In addition, the transmission history generation unit 384 generates transmission history information indicating transmission process history corresponding to the image data transmission signal or the transmission result information for each piece of the image data, and outputs the transmission history information to the transmission result screen addition processing unit 386.

For example, in a case where the transmission history generation unit 384 receives image data transmission signal but does not receive transmission result information for certain image data, it generates transmission history information indicating “transmission in progress” for the image data.

In addition, for example, in a case where the transmission history generation unit 384 receives transmission result information indicating transmission fails for certain image data, it generates transmission history information indicating “transmission error” for the image data.

The transmission result screen addition processing unit 386 extracts information (transmission history screen information) indicating a transmission history screen from the transmission history screen DB 388, and modifies the transmission history screen information so as to perform display corresponding to the received transmission history information.

Specifically, the transmission result screen addition processing unit 386 designates at which position of the transmission history screen the transmission result screen is displayed, and adds the positional information to the transmission history screen information.

In addition, the transmission result screen addition processing unit 386 extracts transmission result screen information regarding each piece of image data from the transmission result screen storage unit 382, and performs a process such that a transmission result screen corresponding to the transmission result screen information is displayed at a field of each piece of the image data of the transmission history screen.

That is to say, the transmission result screen addition processing unit 386 correlates the transmission result screen information with the transmission history information, and stores the transmission history and transmission result screen correspondence information exemplified in FIG. 15B, in the transmission history and transmission result screen correspondence storage unit 392.

FIG. 15B is a diagram exemplifying transmission history and transmission result screen correspondence information.

As shown in FIG. 15B, the transmission history and transmission result screen correspondence information includes transmission history information #1, #2, #3 . . . indicating each transmission history. Each piece of the transmission history information includes transmission history identification information containing a file name and the like, state information indicating a transmission state (“error”, “transmitted”, or the like), and identification information of a transmission result screen corresponding to this transmission history.

In addition, the transmission result screen addition processing unit 386 may perform a process such that a reduced image of the transmission result screen is displayed at a field of each piece of image data of the transmission history screen.

When receiving a process execution instruction indicating a “transmission history display process” from the process transition unit 310, the transmission history screen display unit 390 displays a transmission history screen to which the transmission result screen is added through the process in the transmission result screen addition processing unit 386, on the UI device 180.

Specifically, the transmission history screen display unit 390 extracts transmission history and transmission result screen correspondence information from the transmission history and transmission result screen correspondence storage unit 392, and extracts transmission result screen information corresponding to transmission result screen identification information included in each piece of the transmission history information from the transmission result screen storage unit 382.

In addition, the transmission history screen display unit 390 extracts transmission history screen information from the transmission history screen DB 388, displays the transmission history identification information (a file name or the like) and the state information at a predetermined position, and displays the transmission result screen at the position designated by the transmission result screen addition processing unit 386.

Further, in a case where the transmission history screen display unit 390 receives a display removal instruction from the process transition unit 310 because the process in the image processing apparatus 3 is transitioned to another process (a printing process or the like), the display of the transmission history screen is removed.

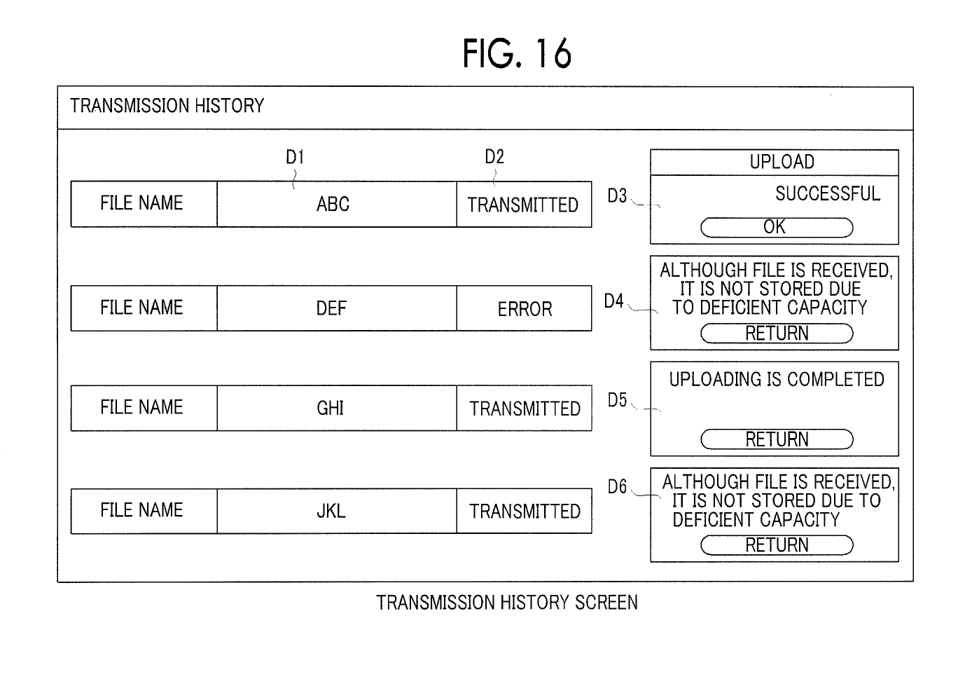

FIG. 16 is a diagram exemplifying a transmission history screen displayed by the transmission history screen display unit 390.

The transmission history screen includes a file name display part D1 for displaying a file name which is an identifier of image data, a transmission situation display part D2 for indicating a transmission situation of the image data, and transmission result screens D3 to D5 regarding the image data.

Here, in relation to image data of the file name “ABC”, transmission result information indicating that image data transmission is successful is received, and transmission result screen information is not received, from the information processing apparatus 2 after the transmission process.

Therefore, as shown in the transmission result screen D3, the transmission result screen generated by the image processing apparatus 3, shown in FIG. 14A, is displayed.

In relation to image data of the file name “DEF”, transmission result screen information is received from the information processing apparatus 2 after the transmission process.

Therefore, as shown in the transmission result screen D4, the transmission result screen generated by the information processing apparatus 2, shown in FIG. 5B, is displayed.

In addition, although “error” is only displayed in the transmission situation display part D2, a detailed error such as that “a file is received but is not stored due to deficient capacity” is displayed in the transmission result screen D4.

In relation to image data of the file name “GHI”, transmission result screen information is received from the information processing apparatus 2 after the transmission process.

Therefore, as shown in the transmission result screen D5, the transmission result screen generated by the information processing apparatus 2, shown in FIG. 5A, is displayed.

In addition, in relation to image data of the file name “JKL”, transmission result information indicating that “transmission is completed” is received and transmission result screen information is also received from the information processing apparatus 2 after the transmission process.

Therefore, although “transmitted” is displayed in the transmission situation display part D2, as shown in the transmission result screen D6, the transmission result screen generated by the information processing apparatus 2, shown in FIG. 5B, is displayed.

As such, even in a case where a transmission result indicates that “transmission is completed”, if a process fails after the information processing apparatus 2 receives image data, a user confirms the transmission result screen later, and thereby may grasp that, actually, the process in the information processing apparatus 2 fails.

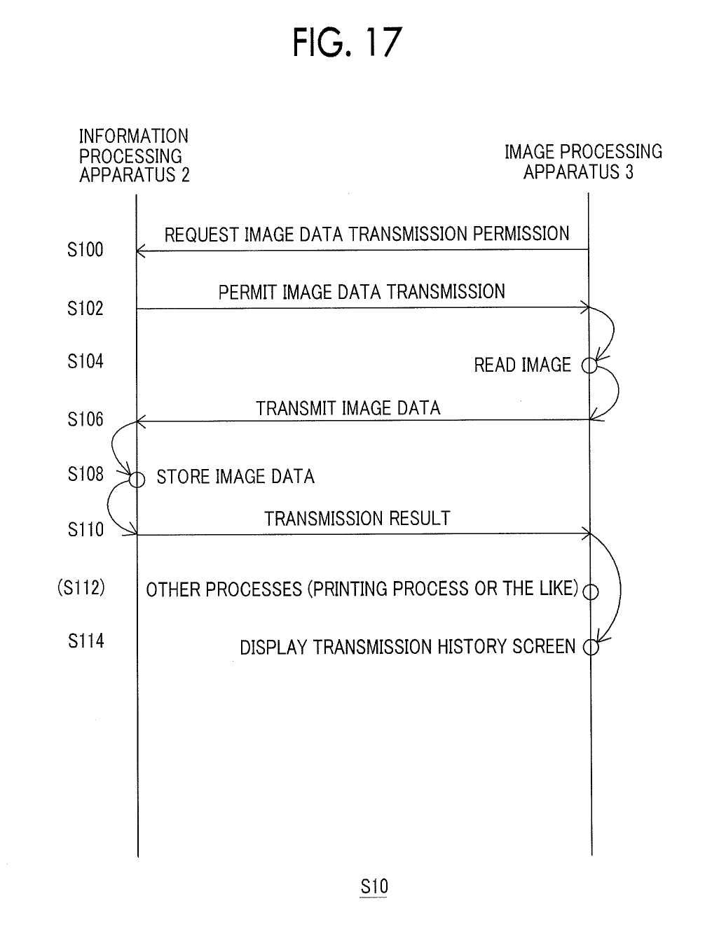

FIG. 17 is a sequence diagram (S10) illustrating the overall processes in the information processing system 1 according to the first exemplary embodiment.

In addition, the order of the following steps may be appropriately altered, and all the steps may not be necessary (this is also true of the following flowchart or the like).

In step S100, the image data transmission permission request transmitting unit 322 of the image processing apparatus 3 transmits an image data transmission permission request to the information processing apparatus 2.

In step S102, the image data transmission permission transmitting unit 226 of the information processing apparatus 2 transmits image data transmission permission to the image processing apparatus 3.

In step S104, the image processing apparatus 3 reads an image from a recording medium, and generates image data.

In step S106, the image processing apparatus 3 transmits the image data to the information processing apparatus 2.

In step S108, the information processing apparatus 2 stores the image data received from the image processing apparatus 3.

In step S110, the information processing apparatus 2 transmits transmission result information to the image processing apparatus 3.

In step S112, the image processing apparatus 3 performs a transition to another process such as a printing process, different from the image data transmission process, in response to an operation from a user so as to execute the process.

In addition, step S112 may be omitted.

In step S114, the transmission history display processing portion 38 of the image processing apparatus 3 displays a transmission history screen to which the transmission result screen is added on the UI device 180.

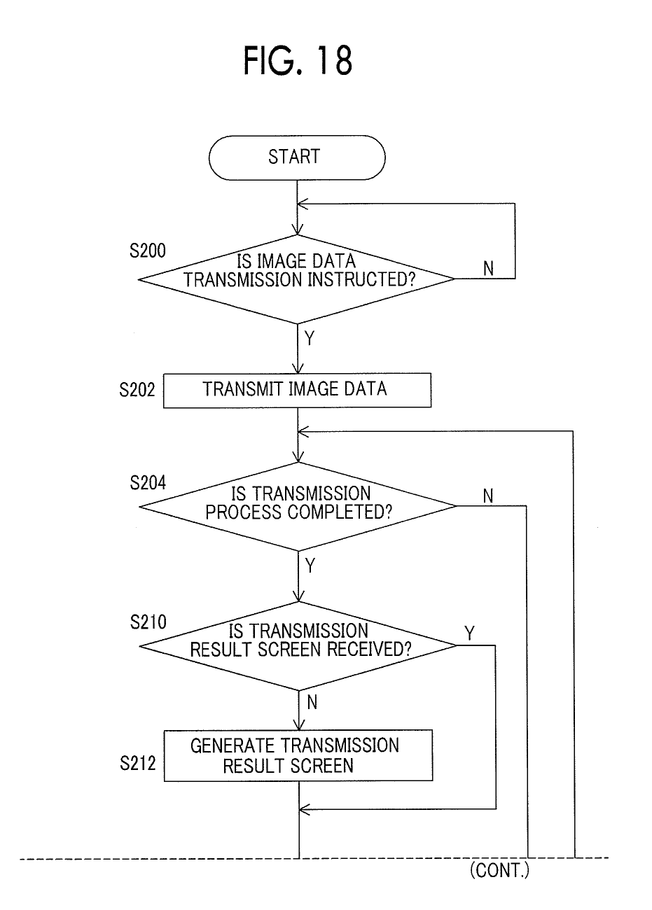

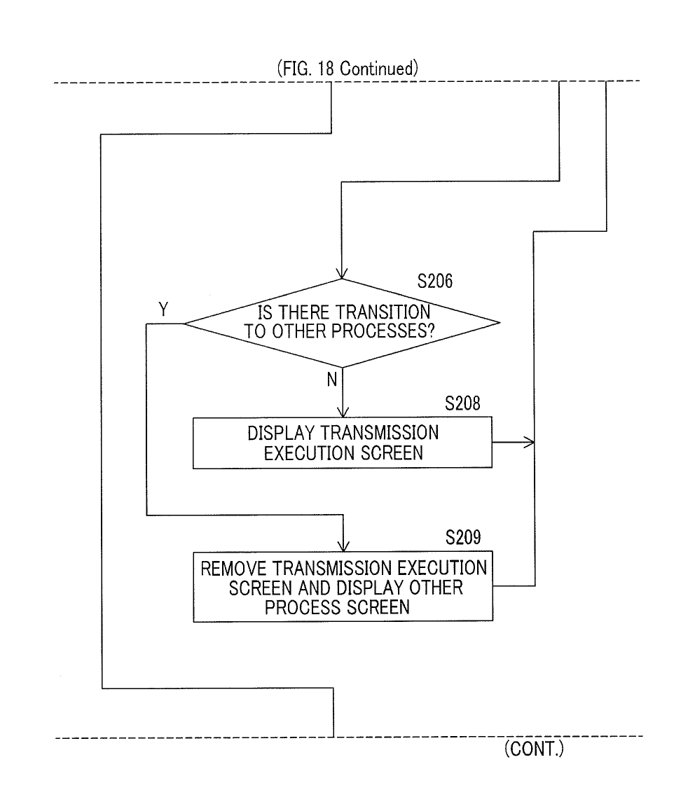

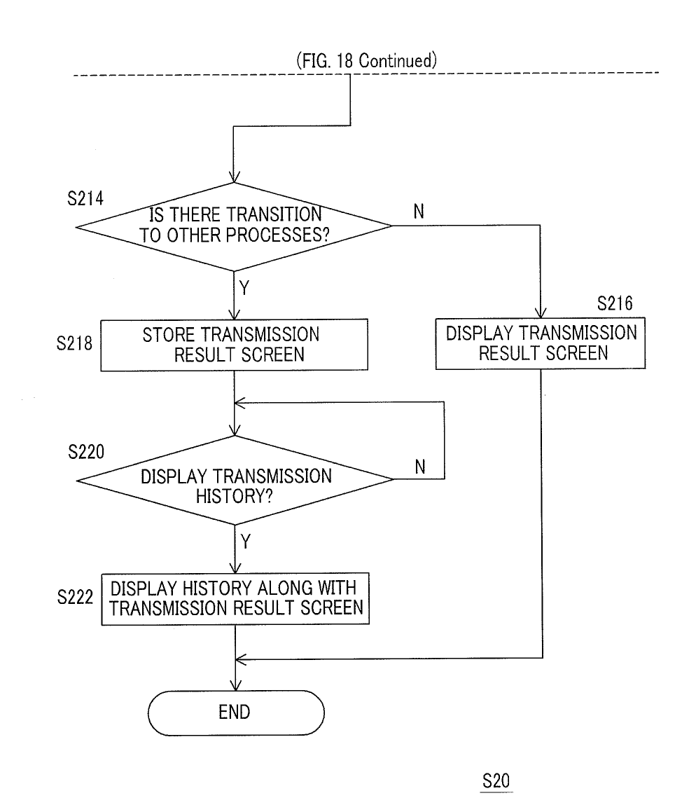

FIG. 18 is a flowchart (S20) illustrating processes after the image data transmission process in the image processing apparatus 3 according to the first exemplary embodiment.

In step S200, it is determined whether or not the image data transmission instruction receiving unit 360 receives image data transmission instruction information from the UI device 180; if received, the flow proceeds to step S202; and if not received, the flow remains in step S200.

In step S202, the image data transmitting unit 364 transmits image data to the information processing apparatus 2.

In step S204, the transmission result receiving unit 370 determines whether or not the image data transmission process is completed; if the transmission process is not completed, the flow proceeds to step S206; and if the transmission process is completed, the flow proceeds to step S210.

In step S206, the transmission execution screen display unit 366 determines whether or not the process in the image processing apparatus 3 is transitioned from the transmission process to another process; if not transitioned to another process, the flow proceeds to step S208; and if transitioned to another process, the flow proceeds to step S209.

In step S208, the transmission execution screen display unit 366 displays the transmission execution screen (FIG. 13) on the UI device 180.

In step S209, the transmission execution screen display unit 366 removes the display of the transmission execution screen and displays a screen regarding another process after the transition.

In step S210, the transmission result screen generation unit 372 determines whether or not transmission result screen information is received from the information processing apparatus 2; if received, the flow proceeds to step S214; and if not received, the flow proceeds to step S212.

In step S212, the transmission result screen generation unit 372 generates a transmission result screen corresponding to the transmission result information.

In step S214, the transition determination unit 374 determines whether or not the process in the image processing apparatus 3 is transitioned to another process (a printing process or the like).

If the process is transitioned to another process, the flow proceeds to step S218, and if the process is not transitioned to another process (that is, if the image data transmission process is in progress), the flow proceeds to step S216.

In step S216, the transmission result display unit 376 displays the transmission result screen on the UI device 180.

In step S218, the transmission result screen storage processing unit 380 stores the transmission result screen information in the transmission result screen storage unit 382.

In step S220, the transmission history screen display unit 390 determines whether or not a process execution instruction indicating a “transmission history display process” is received from the process transition unit 310.

If received, the flow proceeds to step S222, and if not received, the flow remains in step S220.

In step S222, the transmission history screen display unit 390 displays a transmission history screen to which the transmission result screen is added on the UI device 180.

In addition, in the first exemplary embodiment, in a case where there is a transition from the available state to the unavailable state during the image data transmission by the authentication device 194 (for example, a case where there is a transition from the log-in state to the log-out state, or the like), a transmission result screen may not be displayed.

In other words, in a case where there is a transition from the available state to the unavailable state during the image data transmission, and the image processing apparatus 3 is in an unavailable state when receiving the transmission result screen information from the information processing apparatus 2, the transmission result receiving unit 370 may delete the received transmission result screen information, and the transmission result screen generation unit 372 and the transmission result display unit 376 may not perform the process.

In this case, the transmission result screen storage processing unit 380 may not store the transmission result screen information in the transmission result screen storage unit 382, and the transmission history screen display unit 390 may display a transmission history screen to which the transmission result screen is not added on the UI device 180.

Further, in a case where there is a transition from the available state to the unavailable state during the image data transmission, and the image processing apparatus 3 is in an unavailable state when receiving the transmission result screen information from the information processing apparatus 2, the transmission result receiving unit 370 may delete the received transmission result screen information, and the transmission result screen generation unit 372 may generate transmission result screen information corresponding to the transmission result screen shown in FIGS. 14A and 14B even if the transmission result screen information is received from the information processing apparatus 2.

In this case, even if the transmission result screen information is received from the information processing apparatus 2, the transmission history screen display unit 390 may display a transmission history screen to which the transmission result screen generated by the image processing apparatus 3 is added on the UI device 180.

### Second Exemplary Embodiment

Next, a second exemplary embodiment will be described.

An information processing system according to the second exemplary embodiment has the same configuration as the information processing system 1 according to the first exemplary embodiment.

In addition, an information processing apparatus 2 stores the same program as the information processing program 20 shown in FIG. 4.

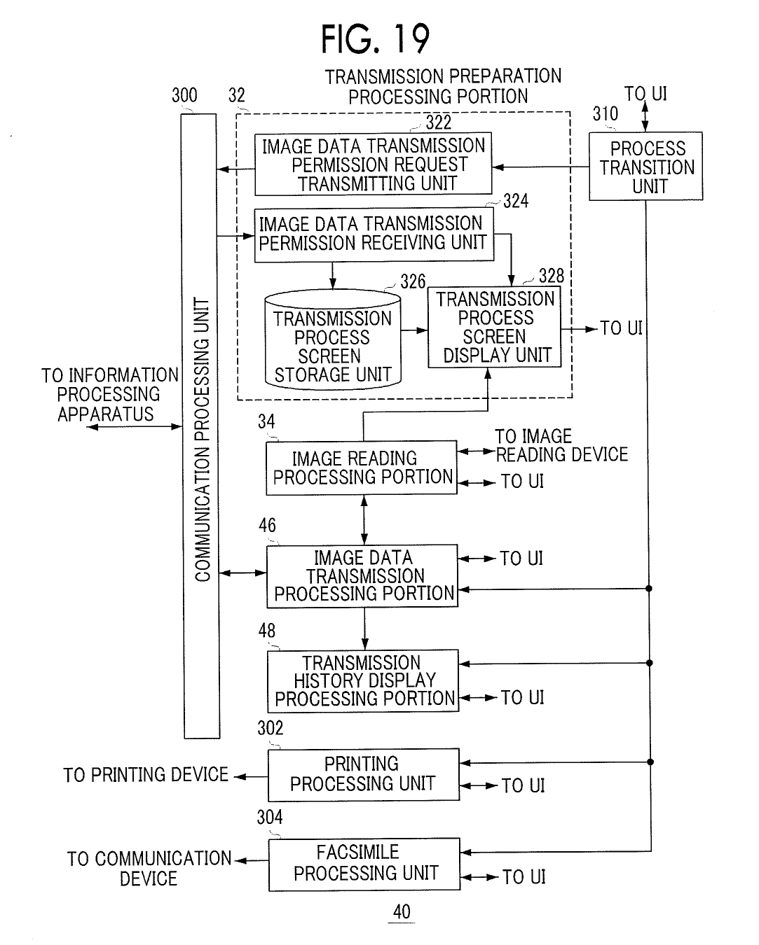

FIG. 19 is a block diagram illustrating an image processing program 40 operated in the image processing apparatus 3 according to the second exemplary embodiment.

As shown in FIG. 19, the image processing program 40 includes a communication processing unit 300, a printing processing unit 302, a facsimile processing unit 304, a process transition unit 310, a transmission preparation processing portion 32, an image reading processing portion 34, an image data transmission processing portion 46, and a transmission history display processing portion 48.

In addition, the image data transmission processing portion 46 and the transmission history display processing portion 48 may be realized by, for example, application software such as a web browser.

Further, description of the constituent elements which are the same as in the first exemplary embodiment, such as the communication processing unit 300, will be omitted (this is also true of other constituent elements).

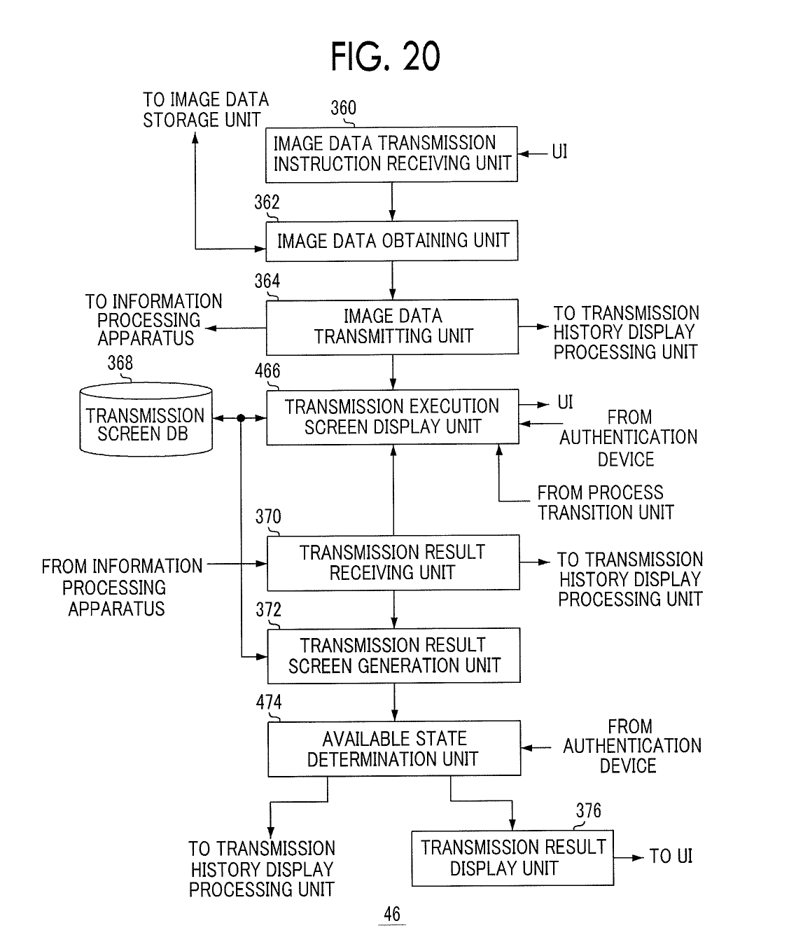

FIG. 20 is a diagram illustrating a configuration of the image data transmission processing portion 46 shown in FIG. 19.

As shown in FIG. 20, the image data transmission processing portion 46 includes an image data transmission instruction receiving unit 360, an image data obtaining unit 362, an image data transmitting unit 364, a transmission execution screen display unit 466, a transmission screen DB 368, a transmission result receiving unit 370, a transmission result screen generation unit 372, an available state determination unit 474, and a transmission result display unit 376.

The transmission execution screen display unit 466, in the same manner as the transmission execution screen display unit 366 according to the first exemplary embodiment, displays a transmission execution screen on the UI device 180, and removes the display of the transmission execution screen by receiving a display removal instruction from the process transition unit 310 when the process in the image processing apparatus 3 is transitioned from the transmission process to other processes by the process transition unit 310.

In addition, the transmission execution screen display unit 466 receives information from the authentication device 194 and determines whether or not the available state to the user is transitioned.

Specifically, the transmission execution screen display unit 466 obtains identification information of a user in an available state from the authentication device 194 during the display of the transmission execution screen, and determines whether or not to match identification information of a user who performs the transmission process.

If it is determined that the identification information of the user in an available state does not match the identification information of the user in an available state when the image data transmitting unit 364 transmits image data (that is, in a case where the user performing the transmission process is in an unavailable state (log-out state)), the transmission execution screen display unit 466 removes the display of the transmission execution screen.

Further, even if the user performing the transmission process is in an unavailable state, a series of transmission processes performed by the image data transmitting unit 364, the transmission result receiving unit 370, the transmission result screen generation unit 372, and the transition determination unit 374 are not stopped, but these processes are continuously performed.

The available state determination unit 474 receives information from the authentication device 194 and determines whether or not the available state of the user is transitioned.

Specifically, when the transmission result receiving unit 370 receives transmission result information, the available state determination unit 474 obtains identification information of a user in an available state from the authentication device 194, and determines whether or not to match identification information of a user performing the transmission process.

If it is determined that the identification information of the user in an available state when the transmission result receiving unit 370 receives the transmission result information matches the identification information of the user in an available state when the image data transmitting unit 364 transmits image data (that is, the user performing the transmission process is in an available state), the available state determination unit 474 outputs transmission result screen information to the transmission result display unit 376.

On the other hand, if it is determined that the identification information of the user in an available state when the transmission result receiving unit 370 receives the transmission result information does not match the identification information of the user in an available state when the image data transmitting unit 364 transmits image data (that is, the user performing the transmission process is in an unavailable state), the available state determination unit 474 correlates transmission result screen information with the identification information of the user performing the transmission process and then outputs it to the transmission history display processing portion 48 so as to display a subsequent transmission result screen.

In addition, in a case where no user is in an available state (that is, no one is in a log-in state) as well, the available state determination unit 474 outputs transmission result screen information to the transmission history display processing portion 48.

Further, in a case where although a user performing the transmission process deviates from an available state and enters an unavailable state, and then the user enters an available state again through an authentication process, the available state determination unit 474 may output transmission result screen information to the transmission result display unit 376.

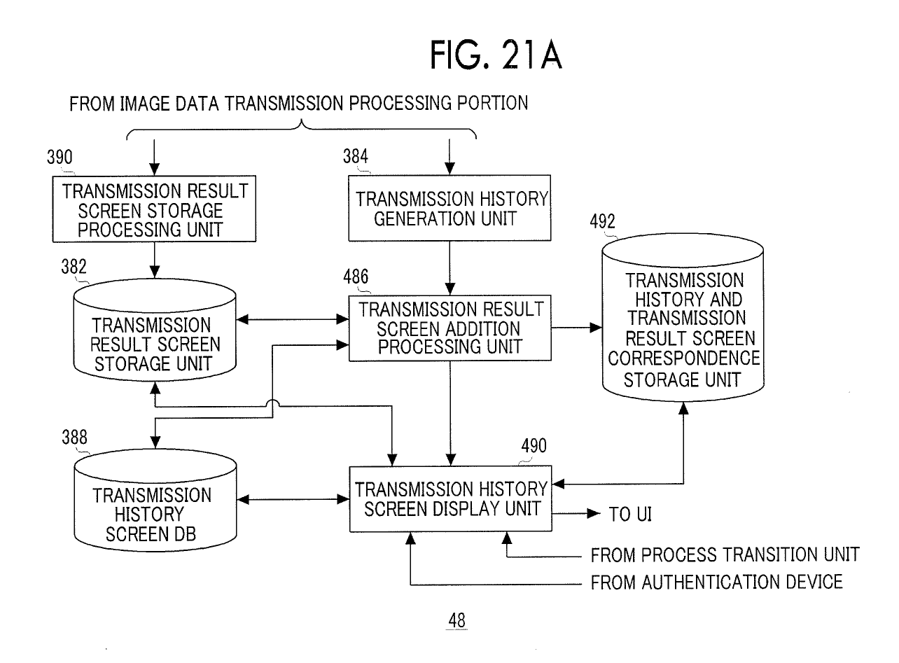

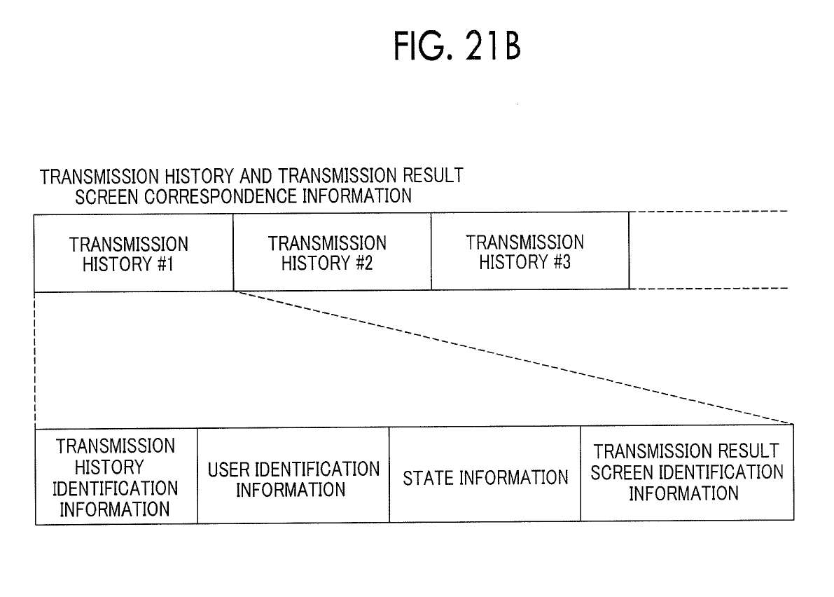

FIGS. 21A and 21B are diagrams illustrating a configuration of the transmission history display processing portion 48 shown in FIG. 19, where FIG. 21A shows a configuration of the transmission history display processing portion 48, and FIG. 21B exemplifies information stored in a transmission history and transmission result screen correspondence storage unit 492 described later.

As shown in FIG. 21A, the transmission history display processing portion 48 includes a transmission result screen storage processing unit 480, a transmission result screen storage unit 382, a transmission history generation unit 384, a transmission result screen addition processing unit 486, a transmission history screen DB 388, a transmission history screen display unit 490, and the transmission history and transmission result screen correspondence storage unit 492.

In the transmission history display processing portion 48, the transmission result screen storage processing unit 480 receives transmission result screen information and identification information of a user performing a transmission process corresponding to the transmission result screen information from the available state determination unit 474 of the image data transmission processing portion 46, and correlates them with each other for storage in the transmission result screen storage unit 382.

The transmission result screen addition processing unit 486 performs the same process as in the transmission result screen addition processing unit 386 according to the first exemplary embodiment.

In addition, the transmission result screen addition processing unit 386 correlates the transmission result screen information, the transmission history information, the identification information of the user performing the transmission process with each other, and stores the transmission history and transmission result screen correspondence information exemplified in FIG. 21B, in the transmission history and transmission result screen correspondence storage unit 492.

FIG. 21B is a diagram exemplifying transmission history and transmission result screen correspondence information.

As shown in FIG. 21B, the transmission history and transmission result screen correspondence information includes transmission history information #1, #2, #3 . . . indicating each transmission history. Each piece of the transmission history information includes transmission history identification information containing a file name and the like, identification information of a user performing a transmission process, state information, identification information of a transmission result screen corresponding to this transmission history.

When receiving a process execution instruction indicating a “transmission history display process” from the process transition unit 310, the transmission history screen display unit 490 displays a transmission history screen (to which the transmission result screen is added) regarding transmission processes performed in the past by a user which is in an available state at that time on the UI device 180.

Specifically, the transmission history screen display unit 490 extracts transmission history and transmission result screen correspondence information from the transmission history and transmission result screen correspondence storage unit 492, and extracts transmission result screen information corresponding to transmission result screen identification information included in each piece of transmission history information regarding a user in an available state from the transmission result screen storage unit 382.

In addition, the transmission history screen display unit 490 extracts transmission history screen information from the transmission history screen DB 388, displays the transmission history identification information (a file name or the like) and the state information at a predetermined position, and displays the transmission result screen at the position designated by the transmission result screen addition processing unit 486.

Further, in the same manner as the transmission history screen display unit 390, in a case where the transmission history screen display unit 490 receives a display removal instruction from the process transition unit 310 because the process in the image processing apparatus 3 is transitioned to another process (a printing process or the like), the display of the transmission history screen is removed.

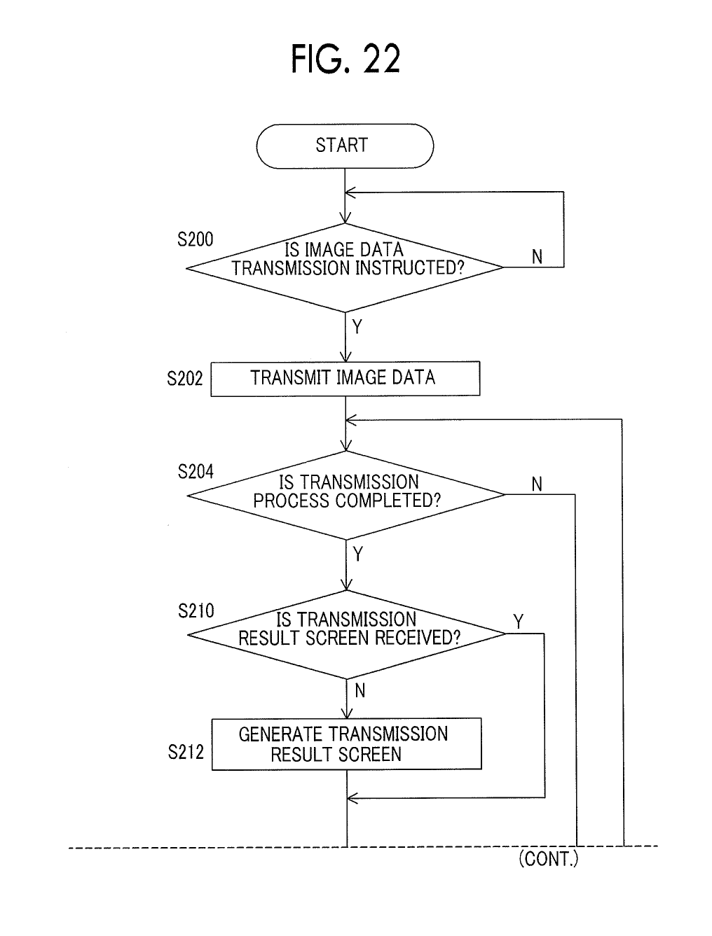

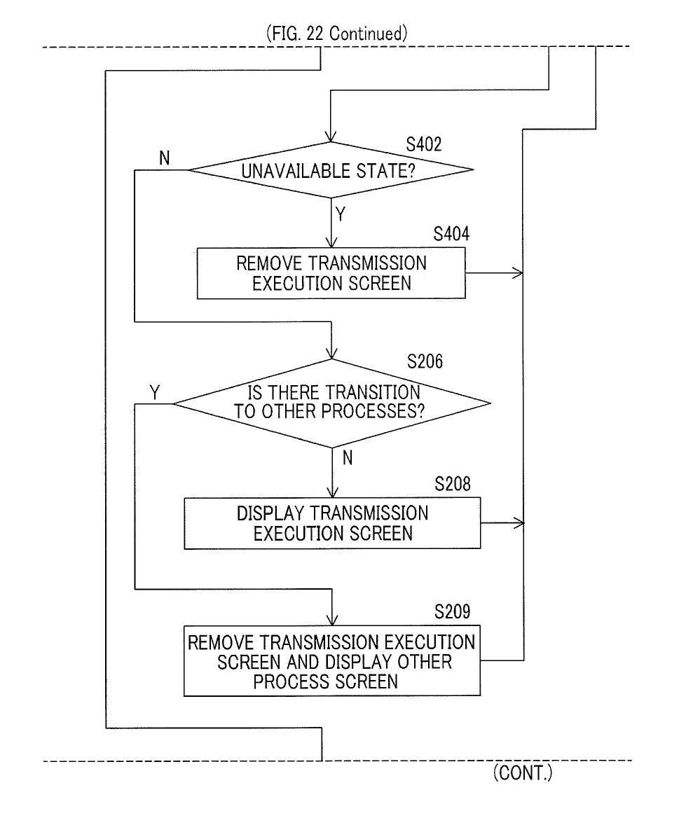

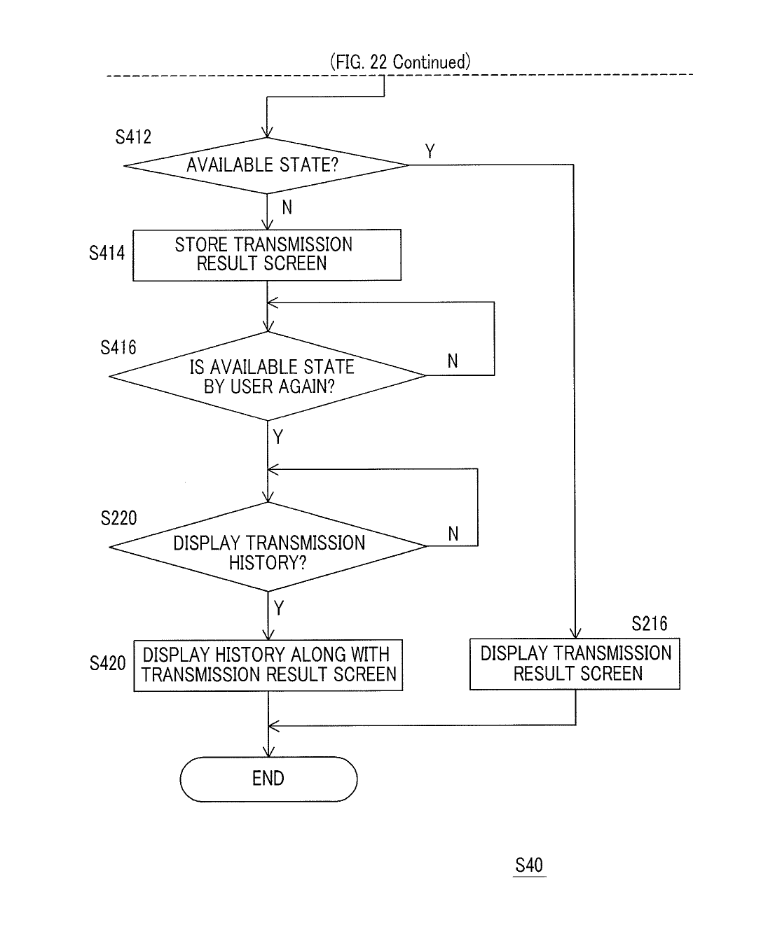

FIG. 22 is a flowchart (S40) illustrating processes after the image data transmission process in the image processing apparatus 3 according to the second exemplary embodiment.

In addition, description of the same processes as the processes shown in FIG. 18 will be omitted.

In step S402, the transmission execution screen display unit 466 determines whether or not a user performing the transmission process is in an unavailable state; if the user is in an unavailable state, the flow proceeds to step S404; and if the user is in an available state, the flow proceeds to step S206.

In step S404, the transmission execution screen display unit 466 removes the display of the transmission execution screen.

In step S412, the available state determination unit 474 determines whether or not the user performing the transmission process is in an available state.

If the user is in an available state, the flow proceeds to step S216, and if the user is in an unavailable state, the flow proceeds to step S414.

In step S414, the transmission result screen storage processing unit 380 correlates the transmission result screen information with identification information of the user performing the transmission process for storage in the transmission result screen storage unit 382.

In step S416, the transmission history screen display unit 490 determines again whether or not the user performing the transmission process is in an available state.

If the user is in an available state, the flow proceeds to step S220, and if the user is still in an unavailable state, the flow remains in step S416.

In step S420, the transmission history screen display unit 490 displays a transmission history screen (to which the transmission result screen is added) regarding transmission processes performed by the user, on the UI device 180.

### Modified Example

Although the transmission result screen is displayed in the transmission history screen in the above-described exemplary embodiments, the transmission result screen may not be displayed in the transmission history screen, and may be displayed in a screen (for example, a screen regarding the printing process) different from the screen regarding the transmission process.

In addition, the transmission result screen does not only include a screen generated when transmission is completed, but also includes a screen (FIG. 13) indicating that transmission is in progress.

At this time, the information processing apparatus 2 may transmit transmission result screen information regarding a transmission result screen regarding the screen indicating that transmission is in progress, to the image processing apparatus 3 in plural steps during the transmission process.

That is to say, the “transmission result screen” does not only include a corresponding screen when the information processing apparatus 2 receives image data, but also includes a screen transmitted to the image processing apparatus 3 while the information processing apparatus 2 receives image data.

In this case, the transmission history display processing portions 38 and 48 may also store information for a corresponding screen during the transmission process (while the information processing apparatus 2 receives image data), and thereafter, in a case where a corresponding screen is received when image data is received from the information processing apparatus 2, the corresponding screen during the transmission process may be removed.

Further, the transmission history display processing portions 38 and 48 may store a transmission result screen displayed immediately before the process is transitioned or immediately before a use state becomes an unavailable state.

In addition, although image data is transmitted from the image processing apparatus 3 to the information processing apparatus 2 in the above-described exemplary embodiments, transmitted data may not be the image data, and, for example, may be text data or the like.

In this case, the first information processing apparatus may not be an image processing apparatus performing an image process.

In addition, although a transmission result screen and a transmission history screen are displayed on the UI device 180 of the image processing apparatus 3, the image processing apparatus 3 may transmit transmission result screen information and transmission history screen information (or transmission history information) to a terminal such as a PC connected thereto via the network 100, and the terminal may display the transmission result screen and the transmission history screen on a display device (a display or the like).

Further, a screen corresponding to the “transmission result screen information” may include a reduced image of the transmission result screen.

In addition, the “transmission result screen information” may not be information (for example, information of only binary data such as a bitmap format) indicating the transmission result screen itself, and may be, for example, information for displaying a message or the like at a predetermined position in the transmission result screen when information such as the message included in the transmission result screen is configured as text data separately and is displayed on the UI device 180 of the image processing apparatus 3.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a transmission component that transmits transmission target information to a transmission destination;
a generation component that generates a transmission result screen based on a result of a transmission by the transmission component;
a storage component that stores relation information between the transmission result screen and a transmission history performed by the transmission component; and
a transmission result screen display component that specifies the transmission history corresponding to the transmission result screen based on the relation information, and displays the transmission result screen along with the specified transmission history.

2. The information processing apparatus according to claim 1, further comprising:
a reception component that receives transmission result screen information generated by the transmission destination from the transmission destination, and
wherein the transmission result screen display component displays a transmission result screen corresponding to the transmission result screen information received by the reception component.

3. The information processing apparatus according to claim 1, wherein the transmission result screen display component displays the transmission result screen in a transmission history screen indicating a history of transmission processes.

4. The information processing apparatus according to claim 1, further comprising:
a processing component that starts another process different from a process performed by the transmission component while the process is performed by the transmission component, and
wherein the transmission result screen display component displays the transmission result screen after the processing component starts another process.

5. The information processing apparatus according to claim 1, further comprising:
an authentication component that authenticates a user, and makes the user enter an available state of the information processing apparatus; and
a canceling component that cancels out the available state by the authentication component, and makes the user enter an unavailable state of the information processing apparatus,
wherein the storage component stores the transmission result screen information in a case where a user performing a transmission process enters an unavailable state by the canceling component, and
wherein the transmission result screen display component displays the transmission result screen regarding a transmission process performed by a user in a case where the user performing the transmission process enters an available state again by the authentication component.

6. The information processing apparatus according to claim 5, wherein the transmission result screen display component displays the transmission result screen regarding a result of the transmission process performed by the user in a case where the user performing the transmission process enters an available state again by the authentication component.

7. The information processing apparatus according to claim 2, wherein the transmission component transmits transmission target information to another information processing apparatus,
wherein the reception component receives a result of a process which is performed for the transmission target information by the another information processing apparatus from the another information processing apparatus, and
wherein the transmission result screen display component displays a transmission result screen corresponding to transmission result screen information received by the reception component and then displays the process result received by the reception component.

8. The information processing apparatus according to claim 1, further comprising:
a transmission screen display component that displays an image regarding the transmission target information in a screen displayed while the transmission component performs a process.

9. An information processing system comprising:
a first information processing apparatus; and
a second information processing apparatus that receives information from the first information processing apparatus and performs a process regarding the received information,
wherein the first information processing apparatus includes
a transmission component that transmits transmission target information to the second information processing apparatus;
a generation component that generates a transmission result screen based on a result of a transmission by the transmission component;
a storage component that stores relation information between the transmission result screen and a transmission history performed by the transmission component; and
a transmission result screen display component that specifies the transmission history corresponding to the transmission result screen based on the relation information, and displays the transmission result screen along with the specified transmission history.

10. A non-transitory computer readable medium storing a program causing a computer to execute a process for performing information process, the process:
transmitting transmission target information to a transmission destination;
generating a transmission result screen based on a result of a transmission by the transmission component;
storing relation information between the transmission result screen and a transmission history performed by the transmission component; and
specifying the transmission history corresponding to the transmission result screen based on the relation information, and displaying the transmission result screen along with the specified transmission history.
